(19) United States
(12) Patent Application Publication
(10) Pub. No.: US 2020/0012653 A1
(43) Pub. Date: Jan. 9, 2020

(54) Measuring Degree Of Match By Importance Of Need And Credibility Of Attributes

(71) Applicant: Metabyte, Inc., Fremont, CA (US)

(72) Inventors: Manu Mehta, Fremont, CA (US); Anjali Dayal, Pleasanton, CA (US); Yiu Wan Lau, Pacheco, CA (US); Aradhana Mehta, Fremont, CA (US); Nitin Mehta, Fremont, CA (US); Saiba Singh, Pleasanton, CA (US); Lynn Randolph Slater JR., Pleasanton, CA (US)

(21) Appl. No.: 16/503,639

(22) Filed: Jul. 5, 2019

Related U.S. Application Data
(60) Provisional application No. 62/694,439, filed on Jul. 5, 2018.

(51) Int. Cl. G06F 16/2457; G06Q 10/06

(52) U.S. Cl. CPC G06F 16/24578; G06Q 10/063112

(57) ABSTRACT

A method and a need matching system (NMS) determine a degree of match between item profiles with item attributes with varying ratings of varying credibility and need profiles with need attributes of varying importance. The NMS receives a first attribute list including the item attributes and a second attribute list including the need attributes from an attribute list database and creates a unique attribute list including unique item attributes, a merged attribute amount measure corresponding to each unique item attribute, and a merged credibility measure indicating credibility of the merged attribute amount measure by performing merging actions on first tuples in the first attribute list. The NMS generates a need match score by processing an attribute match score with an importance measure. The attribute match score is generated for each need attribute in a matched attribute list created by matching the unique item attributes with the need attributes.

### CROSS-REFERENCE TO RELATED APPLICATIONS

This application claims priority to and the benefit of the provisional/non-provisional patent application titled “Measuring Degree Of Match By Importance Of Need And Credibility Of Attributes”, application Ser. No. 62/694,439, filed in the United States Patent and Trademark Office on Jul. 5, 2018. The specification of the above referenced patent application is incorporated herein by reference in its entirety

### BACKGROUND

Many items for which there is a need, for example, products, and/or services, and/or persons are associated with various domains. For example, job seekers have skills and jobs need skills. People need medical treatment, and this need is met by medical practices that provide treatments. A battery may be required for an electronic device, and batteries are available for the devices. A person looking for a romantic meal may desire certain food items and live background music, and restaurants are available that provide food items and music. However, items and needs vary and may not be identical. For example, one restaurant may excel in music but provide only acceptable food, while another may excel in food but only provide acceptable music. A person looking for a romantic meal may value music highly, while another may value food highly. Therefore, there is a need for matching items to needs while taking into account the importance of different aspects of the needs.

Consider an example where job seekers enter an employment marketplace. There is a need for finding jobs that the job seekers may fill. Often the matching of a job to a job seeker is based on a description of a job opening being compared to a resume of a job seeker. However, resumes of job seeker are often inaccurate. Therefore, there is a need for matching a job seeker to job descriptions using information beyond that disclosed in a resume created by the job seeker.

Descriptions of items created by providers of the items often lack desired information, or are inaccurate, for example when they describe only the best attributes of an item, or even when they substantially misstate the attributes of the item. As used herein, “item” refers to an entity, for example, a product such as a battery, a cell phone, etc., or a service such as a teeth cleaning service, or a person offering a service such as a doctor, a job candidate whose service is the skills the job candidate brings to the job, etc., or any entity that can be characterized by attributes. Dissatisfaction with an item often results when the need is filled by an item where the required attributes of the item are not present in the item. The need may be performed inefficiently by the item, and the need may have to be filled again soon. Hence, there is a need for matching items to needs, even when attributes of the item are discovered using information beyond that disclosed in a description created by the item provider.

An alternative source of information about the attributes of an item, for example, music quality, is ratings provided by those claiming to have used or who possess knowledge of the item. As with the information disclosed in a description of the item, the ratings provided by people may be inaccurate, possibly from personal bias or possibly from a lack of knowledge about certain attributes possessed by the item. Furthermore, while using a computer system to determine whether a rating provided for the attributes of an item is accurate is not feasible, the computer system can be programmed to assign a credibility measure to the rating and the credibility of the rating can be a factor when using the rating to match an item to a need. For example, a person who is known to have actually used the item may have a higher credibility in their ratings than one who has not. Or, a user who gives only the best score to every attribute may have their ratings considered less credible. Hence, there is a need for including ratings provided to the items, and also the credibility of each of the ratings, to an item and a need.

Needs often differ. Some of the attributes of an item may be unneeded, others may be required, and only certain amounts of the attribute may be needed. For example, there may be a need for a battery with a 2-year shelf life. One need may consider additional shelf life to be highly desirable, while another need may not consider a longer shelf life to be important. Needs can be characterized by amounts of attributes needed in an item and the importance of those attributes when comparing items to the need.

The number of items that may be considered for a need is generally much larger than a person trying to fill the need can actually consider for satisfying the need. The person seeking to fill a need would prefer to consider only the most suitable items. Conversely, a job seeker would prefer to participate in an interview process only for the jobs for which the job seeker is likely to be a good fit. To identify the most suitable item for a need, there is a need for computing a single numerical score derived from the ratings of the attributes of the item and the credibility of each of the ratings, where the computed single numerical score can be used to sort the highest scoring items to present to the person seeking to fill a need. Hence, there is a need for including the ratings of attributes of the item and credibility of each of the ratings, into a comparison against a need that results in a computation of a single numerical score.

Hence, there is a long felt but unresolved need for a method and a system for determining a degree of match between item profiles with item attributes with varying ratings of varying credibility, and need profiles with need attributes of varying importance by computing a single numerical need match score.

### SUMMARY OF THE INVENTION

This summary is provided to introduce a selection of concepts in a simplified form that are further disclosed in the detailed description of the invention. This summary is not intended to determine the scope of the claimed subject matter.

The method and the system disclosed herein address the above recited need for determining the degree of match between item profiles, for example, job seeker profiles, profiles of restaurants, profiles of physicians, profiles of products, etc., with item attributes, for example, skills and core traits, with varying ratings of varying credibility, and need profiles, for example, job descriptions, food item choices of customers, health conditions of patients, etc., with need attributes, for example, job description attributes, skills of the physician for treating the patients, skills of the restaurants in preparing the food item of choice of the customers, of the needed amounts, etc. and varying importance by computing a single numerical need match score. The method and the system disclosed herein relate to how item profiles are matched to need profiles. The method disclosed herein employs a need matching system comprising at least one processor configured to execute computer program instructions for determining a degree of match between the item profiles with the item attributes with varying ratings of varying credibility, and the need profiles with the need attributes of varying importance and amounts needed. The need matching system computes the single numerical need match score for the degree of match between possessed attributes of an item, for example, a product, or a service, or a person, and needed attributes for a need. The need matching system invokes the method disclosed herein separately for determining the degree of match between different combinations of possessed attributes and needed attributes, for example, by matching the possessed attributes of multiple items against the attributes needed for multiple needs.

The need matching system receives a list of attributes present in item profiles and a list of attributes needed as mentioned in need profiles provided by entities, from an attribute list database. The attribute list database comprises predefined item attributes and need attributes that form the list of attributes present and the list of attributes needed respectively. The item attributes in the list of attributes present occur multiple times with different corresponding amount present measures and different corresponding credibility measures. The list of attributes present is not a unified list. The list of attributes present comprises the item attributes relevant to the item, for example, expertise in Microsoft® Word of Microsoft Corporation when the item is a job seeker, capacity when the item is a battery, ambiance when the item is a restaurant, neurology when the item is a medical provider, etc. The item attributes in the list of attributes present have corresponding item attribute amount measures and credibility measures indicating credibility of the item attribute amount measures. The list of attributes needed comprise the need attributes relevant to the item required to satisfy the need. The need attributes in the list of attributes needed have corresponding importance measures, corresponding requirement measures, and corresponding attribute amount needed measures.

The need matching system processes the list of attributes present and generates a unique attribute list, that is, a merged list of attributes present in the item profiles. The merged list of the attributes present comprises each attribute in the item profiles occurring only once with a merged amount present measure and a merged credibility measure. The need matching system matches the merged list of attributes present by item attribute to the list of attributes needed. The matching results in a list of attributes comprising matched entries with a merged amount present measure and a merged credibility measure, an “is required” (ISREQ) measure, an importance measure, and an amount needed measure. The need matching system computes an attribute match score for each of the matched entries in the merged list of the attributes present. The need matching system computes a need match score defining the degree of match between the possessed attributes of an item and the need attributes for a need by combining the computed attribute match scores. In an embodiment, the need matching system assigns default values to the merged amount present measure and the merged credibility measure when the item attribute is not already in the list of attributes present.

The list of attributes present in the item profiles is generated by operational systems of entities by an assessment of the item attributes present, for example, from reviews of the item profiles and descriptions of the items. The assessments result in identifying an item attribute, and a corresponding amount present measure, and a corresponding measure of credibility of the amount present measure. The list of attributes needed is generated by the operational systems of the entities on assessment of the need attributes needed, for example, from extracts of the need profiles. In an embodiment, the list of attributes needed is generated by the operational systems of the entities using questionnaires. The assessments of the need attributes include identifying a need attribute, indicating an is required (ISREQ) measure of the need attribute using a flag, a measure of the importance of the need attribute, and a measure of the amount of the need attribute needed. In the list of attributes needed, a need attribute is present only once.

The need match score indicates a match of one need profile against one item profile. The computation of the need match score comprises credibility of the assessments and importance of the item attributes to the need, for example, a nearby romantic restaurant. Furthermore, the method for computing the need match score considers the core traits of the items and includes default values for an item attribute amount measure and a credibility measure for unreported core traits.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein.

FIG. 1 illustrates a method for determining a degree of match between item profiles with item attributes with varying ratings of varying credibility and need profiles with need attributes of varying importance.

FIG. 2 exemplarily illustrates a method for generating a need match score implemented by a need matching system on comparison of item attributes with varying ratings of varying credibility with need attributes of varying importance.

FIG. 3 exemplarily illustrates a flow diagram comprising the steps performed by the need matching system for creating a unique attribute list.

FIG. 4 exemplarily illustrates a flow diagram comprising the steps performed by the need matching system for combining multiple occurrences of an item attribute in a first attribute list into a unique item attribute.

FIG. 5 exemplarily illustrates a flow diagram comprising the steps performed by the need matching system for computing a weighted attribute amount measure and a weighted credibility measure for each item attribute in sub-lists of attributes present.

FIG. 6 exemplarily illustrates a flow diagram comprising the steps performed by the need matching system for generating a unique item attribute with a corresponding merged attribute amount measure and a corresponding merged credibility measure.

FIG. 7 exemplarily illustrates a flow diagram comprising the steps performed by the need matching system for combining the unique attribute list and a second attribute list of need attributes to return a matched attribute list.

FIG. 8 exemplarily illustrates a flow diagram comprising the steps performed by the need matching system for generating a single matched attribute from a need attribute contained in the second attribute list and the unique attribute list.

FIG. 9 exemplarily illustrates a flow diagram comprising the steps performed by the need matching system for generating a need match score from the matched attribute list.

FIG. 10 exemplarily illustrates a flow diagram comprising the steps performed by the need matching system for generating a need attribute in the matched attribute list with an associated attribute match score.

FIG. 11 exemplarily illustrates a flow diagram comprising the steps performed by the need matching system for generating a need match score.

FIGS. 12A-12N exemplarily illustrate tabular representations of computations associated with item attributes and need attributes for determining a degree of match between item profiles with the item attributes with varying ratings of varying credibility and need profiles with the need attributes of varying importance.

FIGS. 13A-13N exemplarily illustrate an embodiment of tabular representations of computations associated with item attributes and need attributes for determining a degree of match between item profiles with the item attributes with varying ratings of varying credibility and need profiles with the need attributes of varying importance.

FIGS. 14A-14L exemplarily illustrate another embodiment of tabular representations of computations associated with item attributes and need attributes for determining a degree of match between item profiles with the item attributes with varying ratings of varying credibility and need profiles with the need attributes of varying importance.

FIG. 15 exemplarily illustrates a computer implemented system comprising the need matching system for determining a degree of match between item profiles with item attributes with varying ratings of varying credibility and need profiles with need attributes of varying importance.

### DETAILED DESCRIPTION OF THE INVENTION

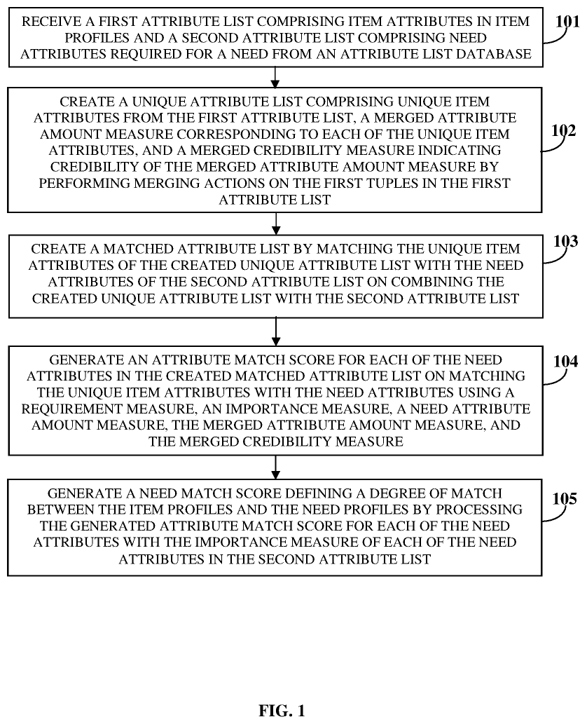

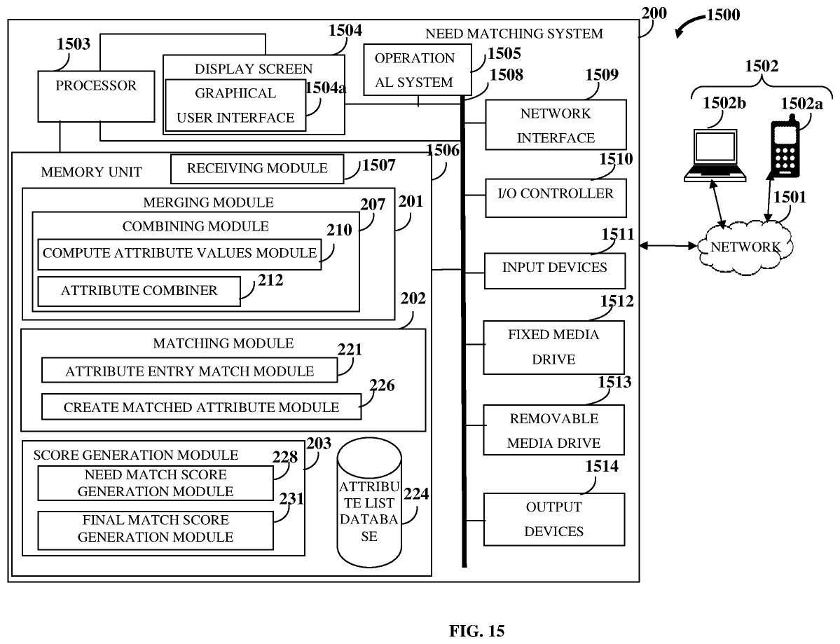

FIG. 1 illustrates a method for determining a degree of match between item profiles with item attributes with varying ratings of varying credibility and need profiles with need attributes of varying importance. As used herein, “item” refers to an entity, for example, a product such as a battery, a cell phone, etc., or a service such as a teeth cleaning service, treatment provided to patients by hospitals, a job role in an organization performed by an employee, etc., or a person or an individual offering a service such as a doctor, a job seeker whose service is the skills the job seeker brings to the job, a tradesman offering certain services such as work on cabinets at a low price rate, an organization such as a hospital, a company, a restaurant, etc., or any entity that can be characterized by attributes. In the method disclosed herein, item attributes are to be matched to need attributes. As used herein, “item attributes” refer to attributes of an item for filling a need smoothly and efficiently. The item attributes for a product comprise core traits of the product. The item attributes for a service or a person comprise core traits and/or domains of expertise of the service or the person. Also, as used herein, “need attribute” refers to a core trait and/or expertise desired out of an item for carrying out a need smoothly and efficiently. The method disclosed herein employs a need matching system 200, as illustrated in FIG. 15. The need matching system comprises at least one processor configured to execute computer program instructions for determining a degree of match between item profiles with item attributes with varying ratings of varying credibility and need profiles with need attributes of varying importance.

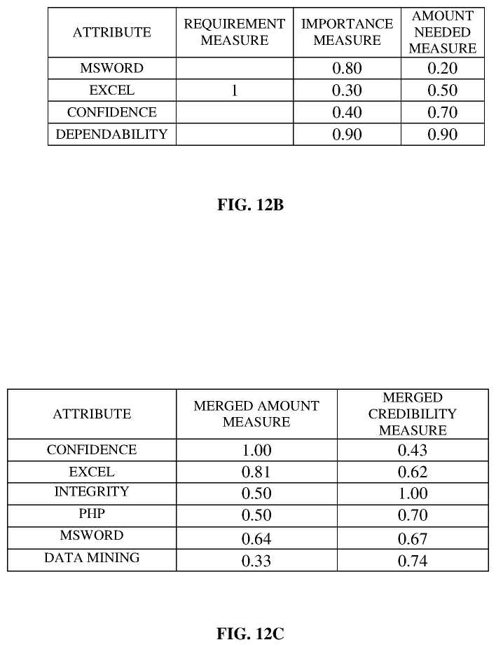

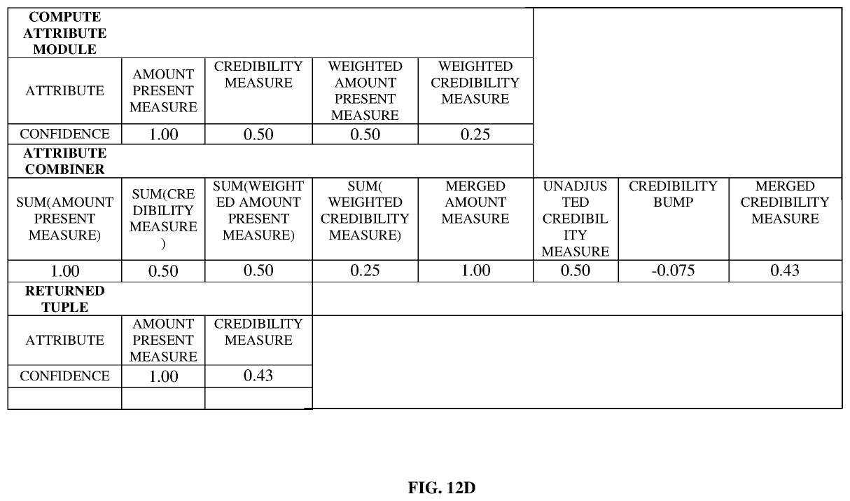

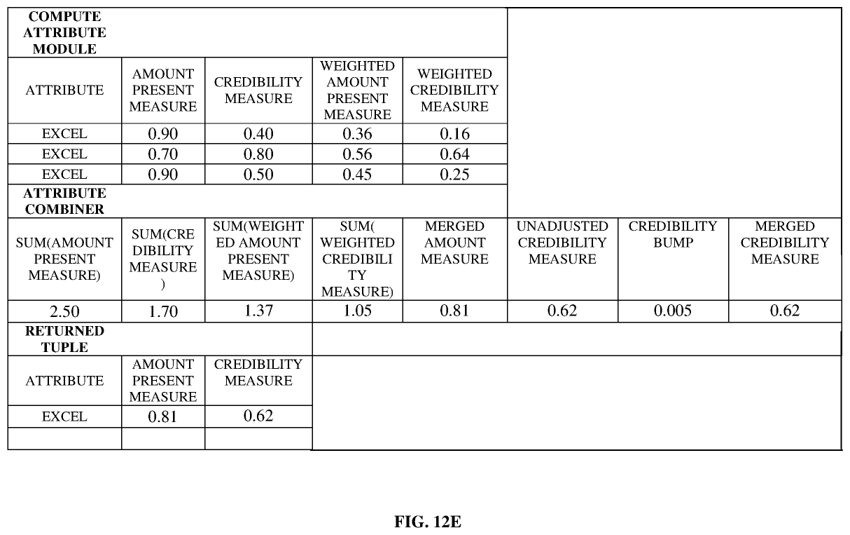

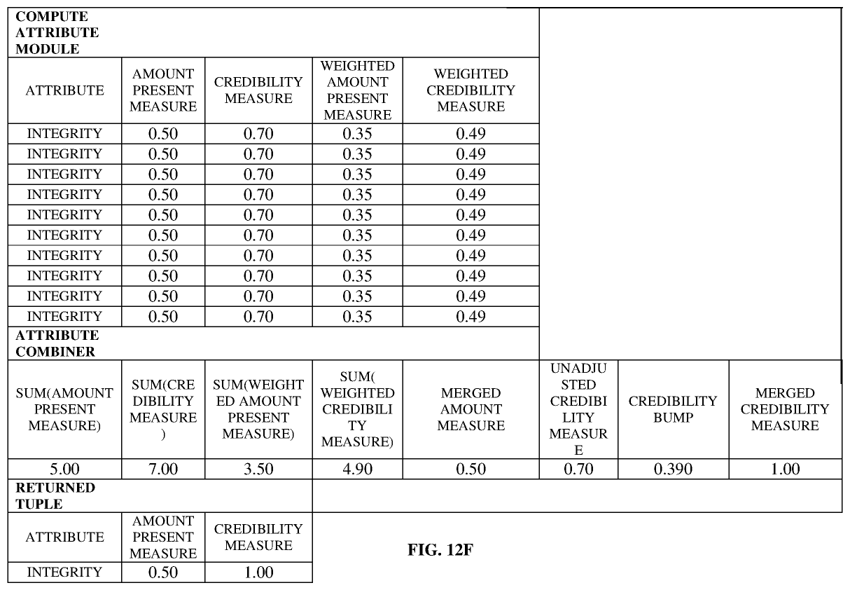

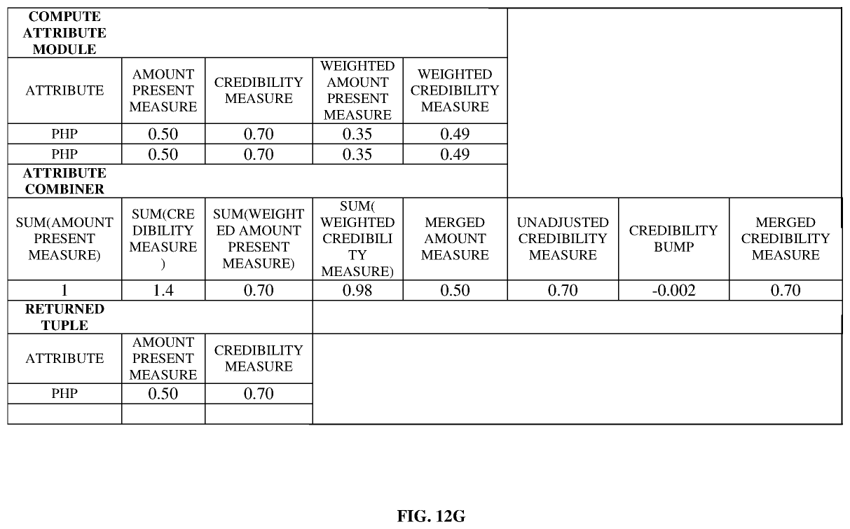

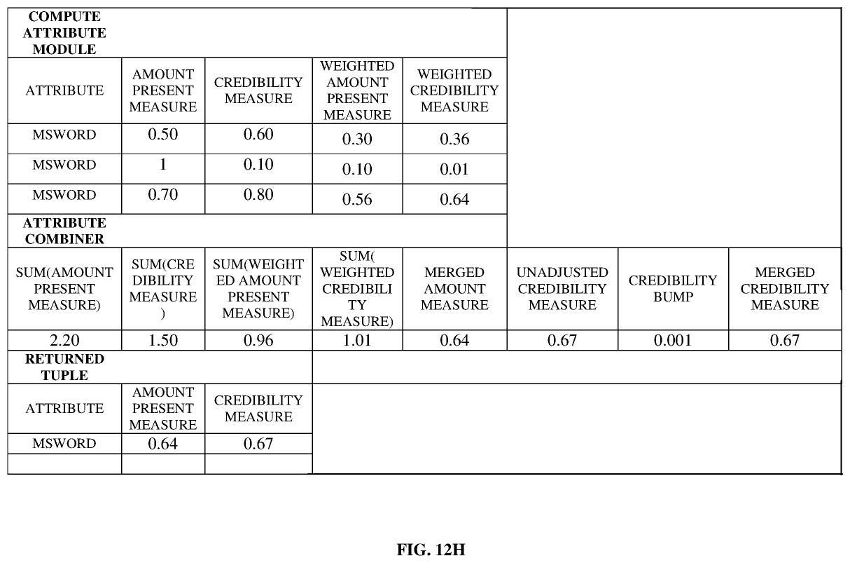

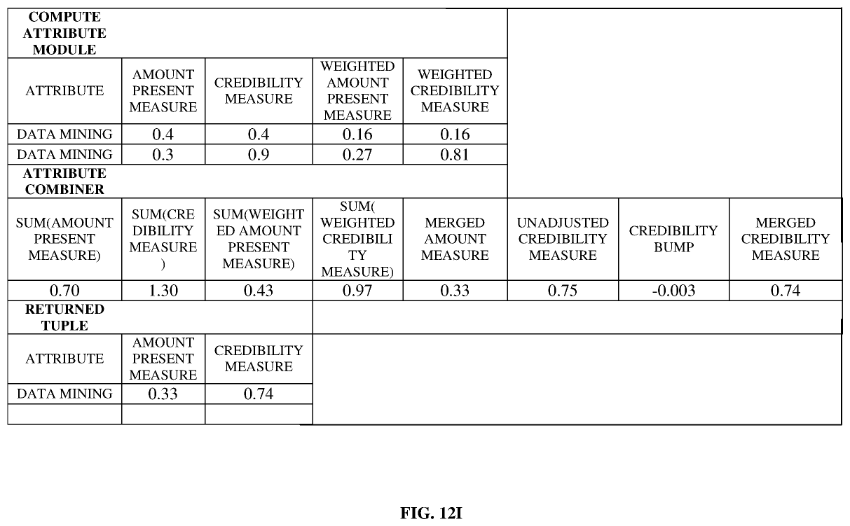

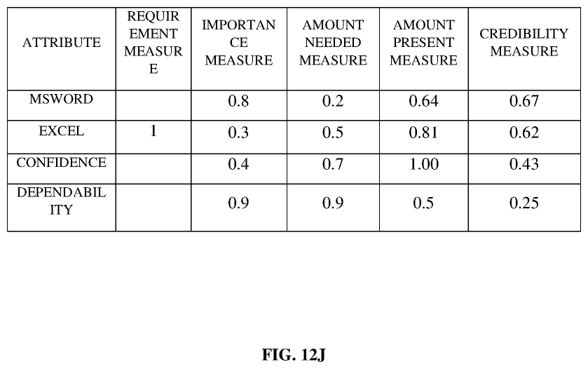

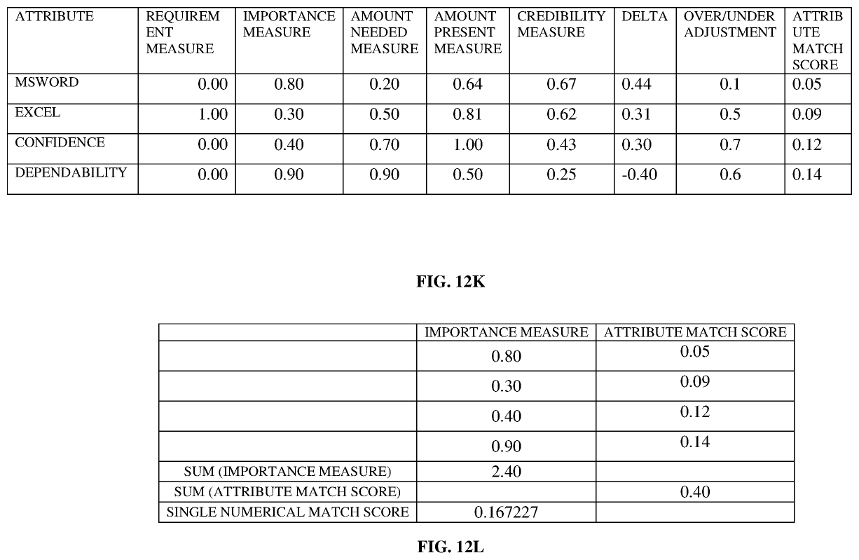

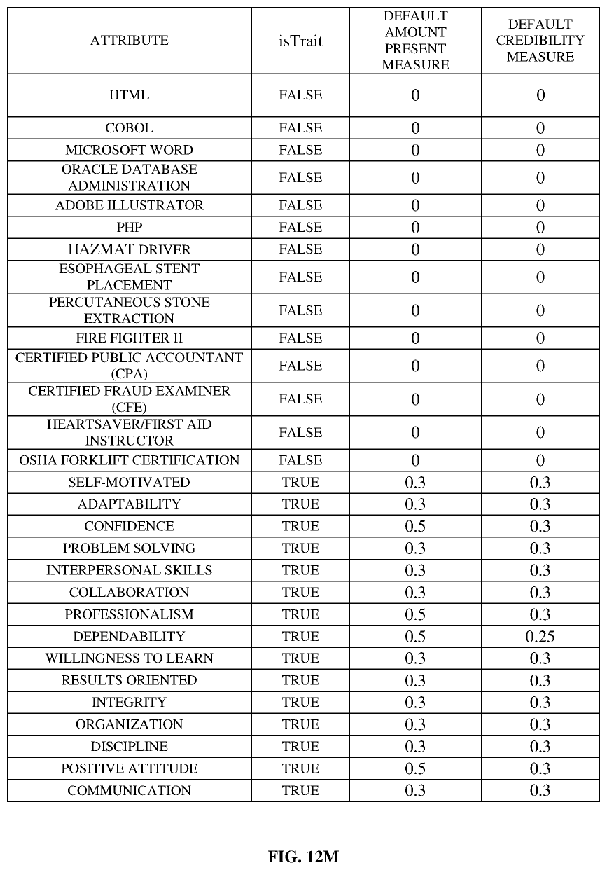

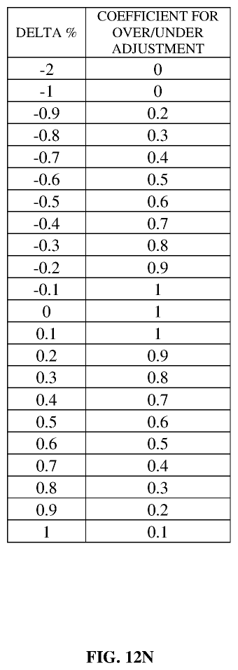

A first attribute list comprises the item attributes and a second attribute list comprises the need attributes. The item attributes and the need attributes are stored in an attribute list database by an operational system, for example, a recruitment system of offices, educational institutes, etc., a hospital information system of hospitals, etc. In the attribute list database, the item attributes and the need attributes are classified into core traits and domains of expertise of items such as services or persons, and classified as only core traits for items such as products. As used herein, “core traits” refer to distinguishing qualities of the items. The core traits are possessed by all items in the need matching system, while the other traits are possessed by some items. For example, every product has quality and durability; every doctor has bedside manner and communication skills; and every restaurant has service quality. The core traits comprise, for example, dependability, integrity, confidence, responsiveness, punctuality, communication, cleanliness, ambience, etc. The core traits in the first attribute list and the second attribute list are flagged using an “isTrait” flag as exemplarily illustrated in FIG. 12M. The domains of expertise are specific to the items. For job seekers, the domains of expertise are job attributes, for example, Microsoft Word, hypertext preprocessor (PHP) programming attributes, etc. For restaurants, the domains of expertise are the expertise of the restaurant in certain food preparations, for example, chicken soup, pepperoni pizza, etc. For physicians, the domains of expertise are knowledge in a specific domain such as orthodontics, orthopedics, pediatrics, etc. For physical items such as products, the core attributes comprise, for example, color, electrical capacity, size, quality, and durability. The first attribute list and the second attribute list are stored in the attribute list database. The item attributes in the attribute list database constitute the first attribute list and the need attributes in the attribute list database constitute the second attribute list.

The first attribute list is a list of the item attributes possessed by the items, stored in the attribute list database, that the need matching system matches to a list of need attributes required for a need, in the second attribute list. The need matching system matches the item attributes of, for example, physicians with the need attributes provided by the patients. That is, the core traits of the physicians, for example, responsiveness, punctuality, communication, etc., and the domains of expertise of the physicians, for example, laparoscopic knee surgery, coronary stents, liposuction of thighs, etc., are matched to the list of core traits and domains of expertise the physicians have to possess for the treatment of the patient. Similarly, the need matching system matches the item attributes of, for example, restaurants with the need attributes needed for serving customers successfully. The customers define the need attributes that are desired from the restaurant. The core traits of the restaurant, for example, cleanliness, ambience, view, etc., and the domains of expertise of the restaurant, for example, expertise in different food preparations such as chicken soup, pepperoni pizza, chocolate cake, etc., are matched by the need matching system to choices of the customers to help the customers select an appropriate restaurant.

An item attribute in the first attribute list has a corresponding item attribute amount measure and a corresponding credibility measure indicating the credibility of the item attribute amount measure. From the item profiles, for example, job profiles such as resumes or reviews of the job seekers, profiles of the restaurants, profiles of the hospitals, a rating of the proficiency of the item is provided by a reviewer associated with the items. The ratings apply to any attribute of the item provided by the entities, for example, the companies, the job seekers, the physicians, the restaurants, etc. As used herein, “item attribute amount measure” refers to a quantized value of the proficiency of the items in the item attributes. The item attribute amount measure is a numerical value between 0 and 1, both inclusive and NULL. The item attribute amount measure represents the degree to which an item attribute is present. A value of 1 of the item attribute amount measure indicates that the item attribute is present to a maximum level possible, that is, the item is highly proficient in the item attribute. A value of 0 of the item attribute amount measure indicates that the item attribute is not present, that is, the item does not possess the item attribute. A value of NULL of the item attribute amount measure indicates that the item attribute is not known. The item attribute amount measure is a fraction of a total attribute amount measure of the item attributes possessed by the items. An item attribute, for example, the ambience possessed by the item, for example, the restaurant is rated by the customer and an item attribute amount measure of 1 is awarded by the customer. The item attribute amount measure of 1 for the item attribute, ambience, indicates the ambience offered by the restaurant is excellent. The core traits in the attribute list database have corresponding default values for the item attribute amount measure and the credibility measure. In an embodiment, the core traits in the attribute list database do not have corresponding default values for the item attribute amount measure and the credibility measure. In another embodiment, the item attributes in the attribute list database have corresponding default values for the item attribute amount measure and the credibility measure.

The operational system of an entity estimates the credibility of the item attribute amount measure corresponding to the item attributes and assigns a credibility measure based on the estimated credibility to the item attribute amount measure. The credibility measure refers to a numerical value between 0 and 1, both inclusive and NULL. The credibility measure represents the probability of the item attribute amount measure being accurate. For example, an item attribute amount measure for an entry, that is, an item attribute, in the first attribute list with a credibility of 0.9 is treated to represent that the item attribute is actually present or is true 9 times out of 10. The credibility measure is a positive number less than 1 and represents the probability of the item attribute amount measure being accurate. Furthermore, any particular item attribute may be present multiple times with possibly different values for the item attribute amount measure and the credibility measure in the first attribute list.

A need attribute in the second attribute list has a corresponding need attribute amount measure, a corresponding requirement measure, and a corresponding importance measure. As used herein, “need attribute amount measure” refers to a quantized value of the proficiency of the items required for the need. The need attribute amount measure is a numerical value between 0 and 1, both inclusive. The need attribute amount measure represents the degree to which the need attribute is required. A value of 1 of the need attribute amount measure indicates that the need attribute is needed to a maximum level possible and a value of 0 of the need attribute amount measure indicates that the need attribute is not needed. A value of 0.2 of the need attribute amount measure indicates that only 20% proficiency in the need attribute is needed from the items for the need. The need attribute amount measure is defined by the entities, for example, companies, customers, patients, etc., seeking services from the items, using the need attributes. For the smooth performance of the service, the entities define the need attributes with corresponding requirement measures and corresponding importance measures.

Also, as used herein, “requirement measure” is a Boolean value associated with a need attribute representing that the item attribute amount measure of the item attribute is required to be equal to the need attribute amount measure of the need attribute, where the need attribute is the same as the item attribute. The requirement measure is associated with need attributes that are basic and mandatory for a need, for example, licenses and certifications such as a medical license for a physician to treat a patient, a certified public accountant (CPA) for auditing accounts of a company, etc.

Also, as used herein, “importance measure” is a quantized value representing a degree to which presence of a need attribute in the first attribute list is required for a need. That is, the importance measure is the weightage associated with an item attribute for the need. The importance measure is a numerical value between 0 and 1, both inclusive. A need attribute with an importance measure of 0.1 is considered to be barely important for the need, and a need attribute with an importance measure of 0.9 is considered to be very important.

In the method disclosed herein, the need matching system receives 101 the first attribute list comprising the item attributes in the item profiles and the second attribute list comprising the need attributes required for a need from the attribute list database. The first attribute list comprises first tuples. Each of the first tuples comprises one of the item attributes, the item attribute amount measure corresponding to the item attribute, and the credibility measure indicating the credibility of the item attribute amount measure. The second attribute list comprises second tuples. Each of the second tuples comprises one of the need attributes, the requirement measure, the importance measure, and the need attribute amount measure associated with the need attribute.

The need matching system creates 102 a unique attribute list comprising unique item attributes from the first attribute list, a merged attribute amount measure corresponding to each of the unique item attributes, and a merged credibility measure indicating the credibility of the merged attribute amount measure by performing merging actions on the first tuples in the first attribute list. In performing the merging actions, the need matching system computes the merged attribute amount measure and the merged credibility measure corresponding to each of the unique item attributes using the item attribute amount measure and the credibility measure of each of the item attributes of the first attribute list as disclosed in the detailed description of FIGS. 12A-12N. As used herein, “unique item attributes” refers to item attributes with multiple occurrences in the first attribute list that are merged to a single occurrence. Also, as used herein, a “merged attribute amount measure” refers to a combined value of the item attribute amount measures corresponding to the multiple occurrences of the item attributes in the first attribute list. Also, as used herein, a “merged credibility measure” refers to a combined value of the credibility measures corresponding to the multiple occurrences of the item attributes in the first attribute list.

The need matching system merges multiple reports or occurrences of an item attribute where the reports are of mixed credibility measures. That is, the item attributes in the first attribute list have item attribute amount measures provided by reviewers of varied credibility and thus, the item attribute amount measures have mixed credibility measures. The need matching system determines a merged credibility measure of 0.13 for two reports of low credibility measures of 0.9 and two reports of high credibility measures of 0.1 indicating the reports with the low credibility measures have minimal impact on the merged credibility measure, instead of averaging out the credibility measures of 0.9 and 0.1 to a merged credibility measure of 0.5. Consider an example where 15 reports of an item attribute amount measure of 0.80 of an item attribute such as the hypertext preprocessor (PHP) programming language with a credibility measure of 0.50 are present in the first attribute list and 2 reports of another item attribute with the same item attribute amount measure and the same credibility measure are also present in the first attribute list. The need matching system determines, in the above example, that the 15 reports of the item attribute amount measure of 0.80 for the PHP programming language with the credibility measure of 0.50 has a higher merged credibility measure than the 2 reports of another item attribute with the same item attribute amount measure and credibility measure.

The need matching system creates 103 a matched attribute list by matching the unique item attributes of the created unique attribute list with the need attributes of the second attribute list on combining the created unique attribute list with the second attribute list as disclosed in the detailed description of FIGS. 12A-12N. The need matching system generates 104 an attribute match score for each of the need attributes in the created matched attribute list on matching the unique item attributes with the need attributes using the requirement measure, the importance measure, the need attribute amount measure, the merged attribute amount measure, and the merged credibility measure as disclosed in the detailed description of FIGS. 12A-12N. For the generation of the attribute match score for each of the need attributes, the need matching system determines deviations in the merged attribute amount measure and the need attribute amount measure using an amount measure deviation lookup table.

Furthermore, the need matching system generates 105 a need match score defining the degree of match between the item profiles and the need profiles by processing the generated attribute match score for each of the need attributes with the importance measure of each of the need attributes in the second attribute list. The need matching system also determines whether a need attribute is absent in the created unique attribute list and assigns default values to the merged attribute amount measure and the merged credibility measure corresponding to the need attribute in the matched attribute list as disclosed in the detailed description of FIGS. 12A-12N.

The need matching system has multiple areas of applications. In an embodiment, the need matching system is used in an employment process. The need matching system can be used for matching of job seekers to jobs in the employment process. In an embodiment, the need matching system is used for matching customers with certain item attributes to a business. In an embodiment, the need matching system is used for matching diners with certain item attributes to a restaurant. In an embodiment, the need matching system is used for matching lawyers with item attributes, for example, stock option plan creation, deposition taking, responsiveness, communication, etc., to entities such as companies. The reviewers need not read text heavy opinions and types of reviews comprising ratings in the form of stars, provided on websites, for example, www.yelp.com of Yelp Inc., www.amazon.com of Amazon.com, Inc., etc., to determine a matching need and a matching item respectively. The reviewers can arrive at, for example, a purchasing decision, a hiring decision, an employment decision, etc., at the earliest using the need matching system. The need matching system gauges the items across different item attributes with uniformity. The output of the need matching system, the single numerical score corresponding to the item profiles and the need profiles can be used for advanced computing analysis such as machine learning for further analysis.

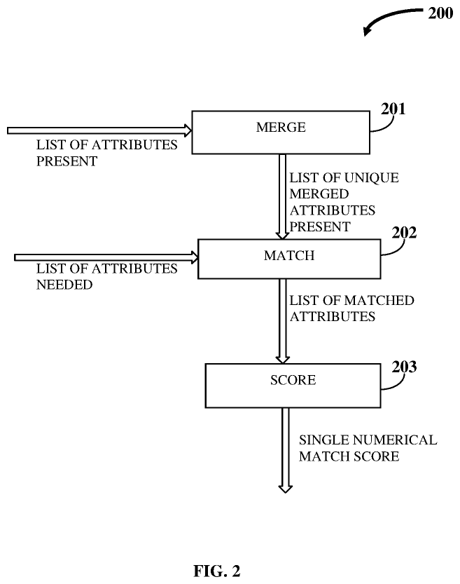

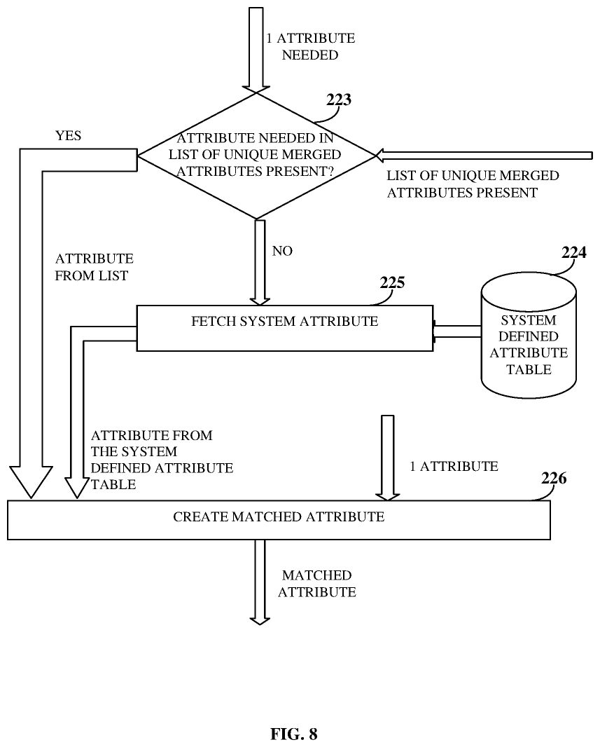

FIG. 2 exemplarily illustrates a method for generating a need match score implemented by the need matching system 200 on comparison of the item attributes with varying ratings of varying credibility with the need attributes of varying importance. As exemplarily illustrated in FIG. 2, the need matching system 200 comprises a merge module 201, a match module 202, and a score module 203. The merge module 201 performs merging actions on the item attributes in a list of attributes present, that is, the first attribute list. The merge module 201 returns a list of unique merged attributes present, that is, the unique attribute list. The need matching system 200 invokes the match module 202 with the list of unique merged attributes present and a list of attributes needed, that is, the second attribute list. The match module 202 combines the list of unique merged attributes present and the list of attributes needed and returns a list of matched attribute entries, that is, the matched attribute list. The match module 202 comprises an attribute entry match module 221 exemplarily illustrated in FIG. 7, for receiving the list of matched attribute entries. The attribute entry match module 221 returns a list of matched attributes. The need matching system 200 invokes the score module 203 with the list of matched attributes. The score module 203 returns a single numerical match score, that is, the need match score.

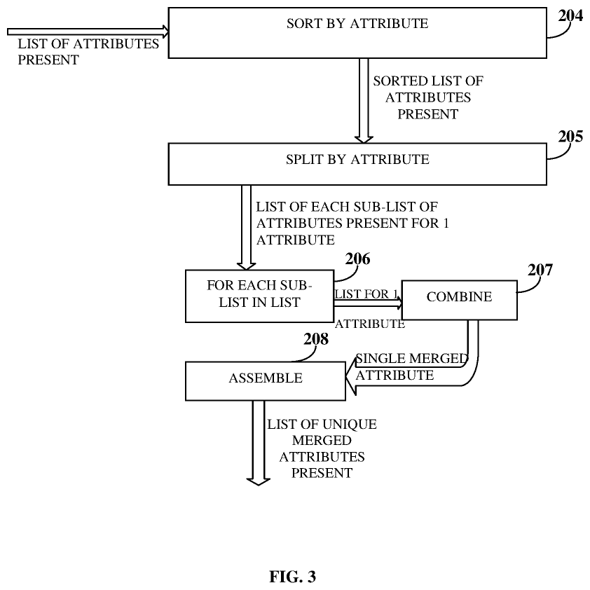

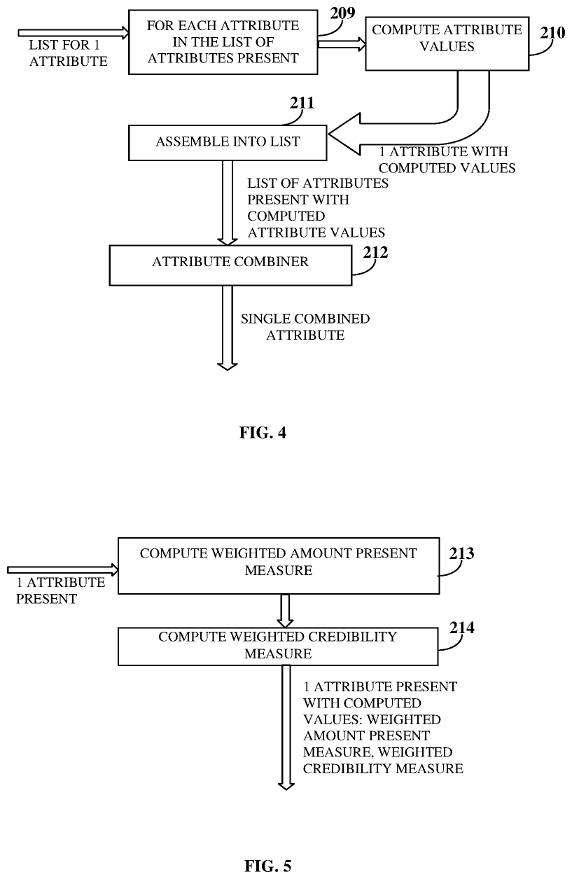

FIG. 3 exemplarily illustrates a flow diagram comprising the steps performed by the merge module 201 of the need matching system 200 exemplarily illustrated in FIG. 2, for creating the list of unique merged attributes present, that is, the unique attribute list comprising the unique item attributes, that is, the attributes present, a corresponding merged attribute amount measure, and a corresponding merged credibility measure. The merge module 201 combines multiple entries, that is, multiple occurrences of the item attributes in the list of attributes present into one entry per item attribute in the list of unique merged attributes present with a combined amount present measure, that is, the merged amount measure, and a combined credibility measure, that is, the merged credibility measure. The need matching system 200 invokes the merge module 201 with a list of attributes present. The merging module 201 sorts 204 the entries in the list of attributes present by the item attributes and then splits 205 the list of attributes present into N sub-lists of attributes present, where each sub-list of attributes present contains entries for a common attribute, that is, for a single item attribute. The merge module 201 comprises a combine module 207 for generating a single merged attribute, that is, a unique item attribute from each of the N sub-lists of attributes present 206 as disclosed in the detailed description of FIG. 4. The merge module 201 assembles 208 the unique item attribute from each of the N sub-lists of attributes present 206 into a new list of unique merged attributes present. A list of the unique merged attributes present, that is, the unique attribute list is the output of the merge module 201.

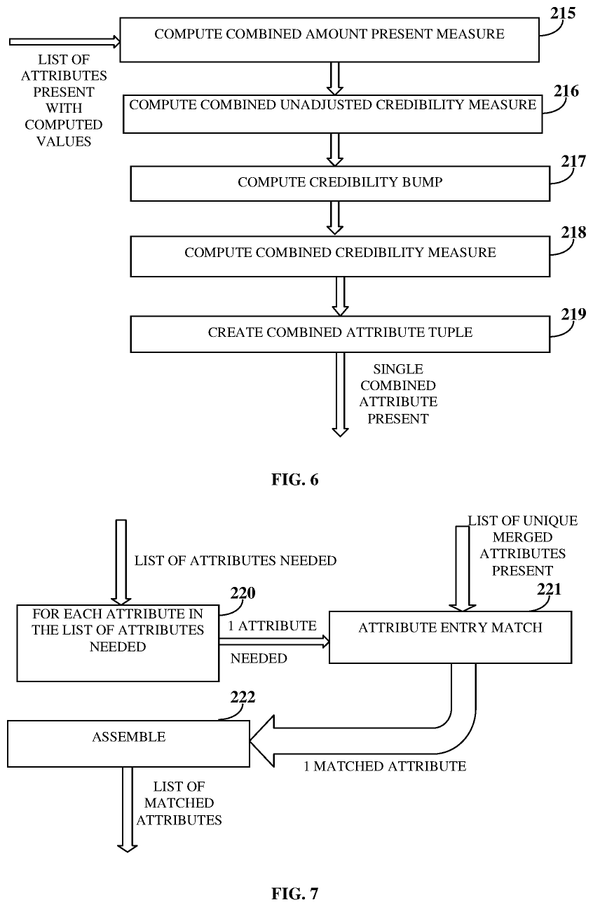

FIG. 4 exemplarily illustrates a flow diagram comprising the steps performed by the combine module 207 exemplarily illustrated in FIG. 3, of the need matching system 200 exemplarily illustrated in FIG. 2, for combining multiple occurrences of an item attribute in the first attribute list, that is, the list of attributes present into a single merged attribute, that is, a unique item attribute with a corresponding merged amount measure and a corresponding merged credibility measure. The need matching system 200 invokes the combine module 207 with a sub-list of attributes present 206 as disclosed in the detailed description of FIG. 3, such that each entry in the sub-list of attributes present 206 is for the same item attribute. In an embodiment, the N sub-list of attributes present 206 comprises the item attributes extracted by the operational system of the entity from different item profiles, for example, resumes and reviews of job seekers. The combine module 207 comprises a compute attribute values module 210 and an attribute combiner 212. The compute attribute values module 210 computes attribute values, that is, a weighted attribute amount measure and a weighted credibility measure for each item attribute in the N sub-lists of attributes present 209 as disclosed in the detailed description of FIG. 5. The compute attribute values module 210 adds values for the weighted attribute amount measure and the weighted credibility measure to each item attribute in the N sub-lists of attributes present 206 to create tuples in the N sub-lists of attributes present 206 as disclosed in the detailed description of FIG. 6. The combine module 207 assembles 211 the single sub-list of attributes present 206 comprising the item attributes with corresponding computed attribute values into a list. The attribute combiner 212 returns a single merged or combined attribute, that is, a unique item attribute on combining the enhanced attributes present tuples, that is, the tuples with the item attributes and corresponding weighted attribute amount measures and corresponding weighted credibility measures as disclosed in the detailed description of FIG. 6.

FIG. 5 exemplarily illustrates a flow diagram comprising the steps performed by the need matching system 200 exemplarily illustrated in FIG. 2, for computing attribute values, that is, a weighted attribute amount measure and a weighted credibility measure for each item attribute in the N sub-lists of attributes present 206 exemplarily illustrated in FIG. 3. The compute attribute values module 210 computes 213 a weighted amount present measure as attribute amount measure*credibility measure of the item attribute. The compute attribute values module 210 computes 214 a weighted credibility measure as credibility measure*credibility measure of the item attribute. The compute attribute values module 210 returns an item attribute in the sub-list of attributes present 206 with the computed values of the weighted amount present measure and the weighted credibility measure.

In the computation of the weighted amount present measures and the weighted credibility measures of the item attributes in the N sub-list of attributes present 206, the credibility measures affect the weightage provided to the item attribute amount measures of the item attributes in the N sub-list of attributes present 206. The credibility measures also affect the weightage provided to the credibility measures. A sum of the weighted credibility measures of an item attribute in a sub-list of attributes present 206 is used to calculate a credibility adjustment, that is, a credibility bump that is added to an unadjusted credibility measure to generate a merged credibility measure of the item attribute as disclosed in the detailed description of FIG. 6.

FIG. 6 exemplarily illustrates a flow diagram comprising the steps performed by the need matching system 200 exemplarily illustrated in FIG. 2, for generating a unique item attribute with a corresponding merged attribute amount measure and a corresponding merged credibility measure. The attribute combiner 212 exemplarily illustrated in FIG. 4, receives a sub-list of attributes present 206 exemplarily illustrated in FIG. 3, with the computed values of the weighted amount present measure and the weighted credibility measure and creates a single combined attribute, that is, a unique item attribute. The need matching system 200 invokes the attribute combiner 212 with a sub-list of attributes present 206 with computed values such that all entries in the sub-list of attributes present 206 are for the same item attribute. The attribute combiner 212 computes 215 a combined amount present measure, that is, the merged attribute amount measure as Sum(weighted amount present measure)/Sum(credibility measure). The attribute combiner 212 computes 216 a combined unadjusted credibility measure as Sum(weighted credibility measure)/Sum(credibility measure). The attribute combiner 212 computes 217 a credibility bump as (Sum(weighted credibility measure)*coeff_credbump)−coeff_credbump, where the coefficient coeff_credbump is a predefined constant. In an embodiment, the credibility bump is computed by a lookup of the Sum(weighted credibility measure), for example, as in VLOOKUP in Excel® of Microsoft Corporation. The attribute combiner 212 computes 218 a combined credibility measure, that is, the merged credibility measure, as (combined unadjusted credibility measure+credibility bump) that is adjusted to have a minimum value of 0 and a maximum value of 1. The attribute combiner 212 creates 219 a combined attribute tuple, that is, a tuple in the unique attribute list, comprising the unique item attribute being the attribute from the sub-list of the attributes present with the computed combined amount present measure and the computed combined credibility measure. The attribute combiner 212 returns a single merged attribute or a combined attribute, that is, the unique item attribute. The merge module 201 assembles 208 the unique item attribute from each of the N sub-lists of attributes present 206 into the unique attribute list, that is, the list of unique merged attributes present as disclosed in the detailed description of FIG. 3.

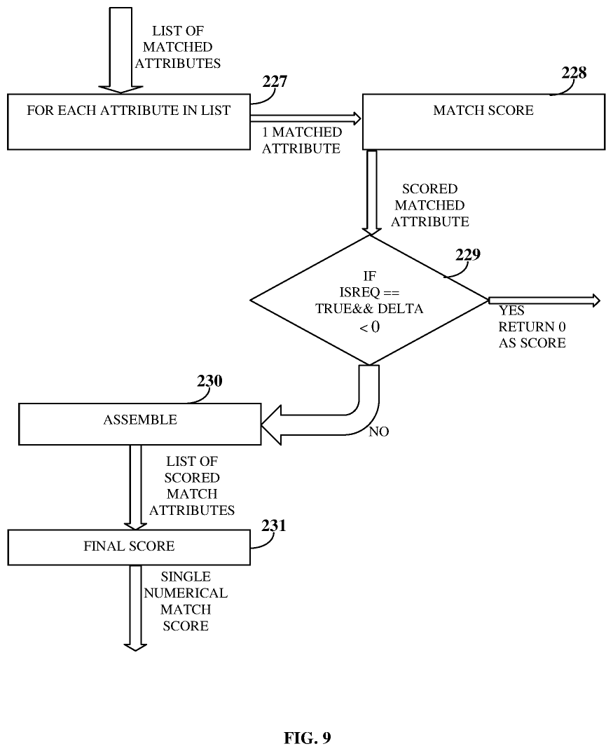

FIG. 7 exemplarily illustrates a flow diagram comprising the steps performed by the need matching system 200 exemplarily illustrated in FIG. 2, for combining the unique attribute list, that is, the list of unique merged attributes present and the second attribute list, that is, the list of attributes needed to return a list of matched attributes, that is, the matched attribute list. For each unique attribute in the list of unique merged attributes needed 220, the need matching system 200 invokes the attribute entry match module 221 with the list of unique merged attributes present and the list of attributes needed. The attribute entry match module 221 returns a single matched attribute that is assembled 222 into the list of matched attributes, that is, the matched attribute list as disclosed in the detailed description of FIG. 8.

FIG. 8 exemplarily illustrates a flow diagram comprising the steps performed by the need matching system 200 exemplarily illustrated in FIG. 2, for generating a single matched attribute from an attribute needed, that is, the need attribute contained in the list of attributes needed, that is, the second attribute list and a list of unique merged attributes present, that is, the unique attribute list. The attribute entry match module 221 exemplarily illustrated in FIG. 7, examines 223 whether the list of unique merged attributes present contains the attribute needed, that is, the need attribute. If the need attribute is present in the list of unique merged attributes present, the attribute entry match module 221 passes the unique item attribute that is the same as the need attribute as an attribute_present to a create matched attribute module 226. If the need attribute is absent in the list of unique merged attributes present, the attribute entry match module 221 fetches 225 the need attribute from a system attribute table 224, that is, the attribute list database and passes the fetched need attribute to the create matched attribute module 226 as an attribute_present. The create matched attribute module 226 accepts the attribute_present and the need attribute and creates a matched attribute tuple comprising a need attribute amount measure, an importance measure, and a requirement measure of the need attribute and a merged attribute amount measure and a merged credibility measure of the attribute_present.

FIG. 9 exemplarily illustrates a flow diagram comprising the steps performed by the score module 203 of the need matching system 200 exemplarily illustrated in FIG. 2, for generating a single numerical match score, that is, the need match score from a list of matched attributes, that is, the matched attribute list. The need matching system 200 invokes the score module 203 exemplarily illustrated in FIG. 2, with the list of matched attributes as disclosed in the detailed description of FIG. 2. In step 227, each matched attribute, that is, a unique item attribute matched with a need attribute from the matched attribute list is passed to a need match score generation module 228 that adds to each matched attribute, additional values of a delta and a match score and generates a scored matched attribute. For example. the need match score generation module 228 receives the input comprising each matched attribute, that is, the unique item attribute matched with the need attribute from the matched attribute list and technically processes the input. The the need match score generation module 228 using the processor 1503 computes the additional values of the delta and the match score, and transforms the input into the scored matched attribute by an algorithm in the need matching system 200 to generates the scored matched attribute. The score module 203 examines 229 whether the matched attribute has an ISREQ value, that is, a requirement measure of TRUE in the second attribute list, and whether a deviation, the delta, is less than zero. If the matched attribute has an ISREQ value of TRUE and if the delta is less than zero, the score module 203 returns a final numerical score, that is, the need match score of zero regardless of any other processing. If the matched attribute does not have an ISREQ value of TRUE and if the delta is more than zero, the score module 203 assembles 230 the scored matched attributes, that is, the matched attributes in the matched attribute list with associated attribute match scores into a list and passes the list to a final score module 231 that returns the single numerical match score.

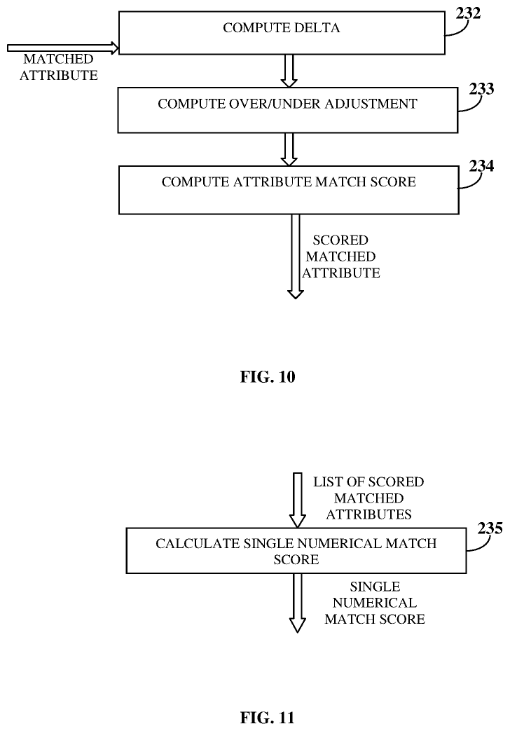

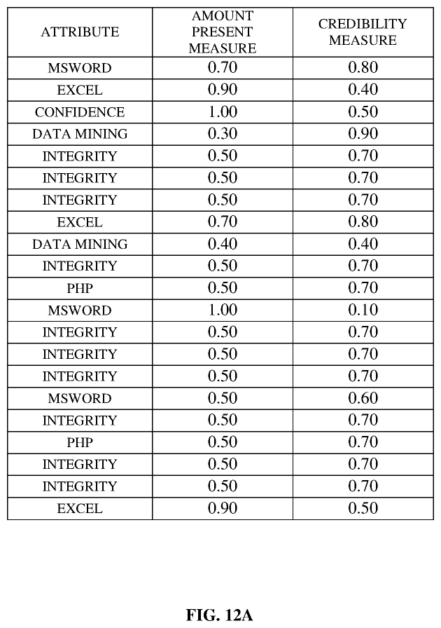

FIG. 10 exemplarily illustrates a flow diagram comprising the steps performed by the need matching system 200 exemplarily illustrated in FIG. 2, for generating a scored match attribute, that is, a need attribute in the matched attribute list with an associated attribute match score. The match score module 228 exemplarily illustrated in FIG. 9, receives the matched attribute, that is, the need attribute matching with an item attribute in the matched attribute list. The match score module 228 computes 232 the delta as difference in the merged attribute amount measure, Amount_Present, and need attribute amount measure, Amount_Needed. That is, the match score module 228 determines deviation in the merged attribute amount measure and the need attribute amount measure as disclosed in the detailed description of FIG. 1. The match score module 228 computes 233 an over/under adjustment using a lookup of (delta/Amount_Needed) against an amount measure deviation lookup table exemplarily illustrated in FIG. 12N, that returns a numerical value for different data ranges of the value of the (delta/Amount_Needed). The match score module 228 further computes 234 an attribute match score as (importance measure*credibility measure*over/under adjustment) for each matched attribute. The match score module 228 adds additional values of delta and the attribute match score to each of the matched attributes and generates scored matched attributes as disclosed in the detailed description of FIG. 9.

FIG. 11 exemplarily illustrates a flow diagram comprising the steps performed by the need matching system 200 exemplarily illustrated in FIG. 2, for generating a need match score, that is, a single numerical match score for the scored matched attributes. The need matching system 200 invokes a final score module 231 exemplarily illustrated in FIG. 9, with a list of scored matched attributes, that is, the matched attributes in the matched attribute list with associated attribute match scores. The final score module 231 calculates 235 a single numerical match score as Sum(attribute match score)/Sum(importance measure). The single numerical match score determines the degree of match between the need attributes and the item attributes.

In an embodiment, the attribute list database is a relational database. The amount measure deviation lookup table and the predefined attribute table 224 exemplarily illustrated in FIG. 8, in an embodiment, form a part of a relational database. The amount measure deviation lookup table and the predefined attribute table 224, in an embodiment, are flat files. The attribute list database, in an embodiment, is a persistent data store.

FIGS. 12A-12N exemplarily illustrate tabular representations of computations associated with item attributes and need attributes for determining a degree of match between item profiles with the item attributes with varying ratings of varying credibility and need profiles with the need attributes of varying importance. FIG. 12A exemplarily illustrates a first attribute list comprising item attributes, for example, MS Word, Excel, confidence, data mining, integrity, hypertext preprocessor (PHP) programming language, etc., extracted from item profiles, for example, resumes and reviews of the job seekers. The item attributes, for example, confidence, integrity, etc., are core traits, and the item attributes, for example, MS Word, PHP programming language, data mining, etc., are domains of expertise of the job seekers. As exemplarily illustrated in FIG. 12A, the first attribute list comprises multiple occurrences of the item attributes in random with corresponding attribute amount measures and corresponding credibility measures. The need matching system 200 receives the first attribute list exemplarily illustrated in FIG. 12A, comprising the item attributes from an attribute list database. The first attribute list comprises first tuples and each of the first tuples comprises an item attribute, an item attribute amount measure corresponding to the item attribute, and a credibility measure indicating credibility of the item attribute amount measure. As exemplarily illustrated in FIG. 12A, a first tuple in the first attribute list comprises an item attribute, for example, CONFIDENCE, the item attribute amount measure, that is, an amount present measure of 1.0, and a credibility measure of 0.50. Another first tuple in the first attribute list comprises EXCEL as an item attribute with a corresponding amount present measure of 0.90 and a corresponding credibility measure of 0.40. The first attribute list comprises multiple first tuples comprising MSWORD as an item attribute with corresponding amount present measures and corresponding credibility measures.

FIG. 12B exemplarily illustrates a second attribute list comprising need attributes required for a need. The second attribute list comprises second tuples and each of the second tuples comprises a need attribute, a need attribute amount measure corresponding to the need attribute, a requirement measure, and an importance measure associated with the need attribute. As exemplarily illustrated in FIG. 12B, a second tuple in the second attribute list comprises a need attribute, for example, MSWORD, a requirement measurement, that is, ISREQ value of NULL, an importance measure of 0.8, and a need attribute amount measure, that is, an amount needed measure of 0.20. Another second tuple comprises, for example, EXCEL as a need attribute with a corresponding requirement measure of 1, an importance measure of 0.30, and an amount needed measure of 0.50. The need matching system 200 receives the second attribute list exemplarily illustrated in FIG. 12B, from the attribute list database.

FIG. 12C exemplarily illustrates a unique attribute list created from the first attribute list exemplarily illustrated in FIG. 12A, by the need matching system 200. The need matching system 200 performs merging actions, that is, splitting and sorting of the first tuples of the first attribute list and computes a merged attribute amount measure, that is, the merged amount measure, and a merged credibility measure as exemplarily illustrated in FIGS. 12D-121. FIGS. 12D-121 exemplarily illustrate 6 sub-lists of the item attributes that are in the first attribute list exemplarily illustrated in FIG. 12A. As exemplarily illustrated in FIG. 12D, the merging module 201 of the need matching system 200 exemplarily illustrated in FIG. 2, creates a sub-list of the item attribute, CONFIDENCE, with a corresponding amount present measure, that is, the item attribute amount measure of 1.00 and the corresponding credibility measure of 0.50. The compute attribute values module 210 exemplarily illustrated in FIG. 4, determines a weighted amount present measure, that is, a weighted attribute amount measure as attribute amount measure*credibility measure=1.00*0.50=0.50, and a weighted credibility measure as credibility measure*credibility measure=0.50*0.50=0.25. The attribute combiner 212 exemplarily illustrated in FIG. 4, computes a merged amount measure, that is, a merged attribute amount measure as Sum(weighted amount present measure)/Sum(credibility measure). Since there is only one occurrence of the item attribute CONFIDENCE in the sub-list, the Sum(amount present measure)=1.00, the Sum(weighted amount present measure)=0.50, and the Sum(credibility measure)=0.50. The attribute combiner 212 computes the merged attribute amount measure as 0.50/0.50=1.00 and an unadjusted credibility measure as Sum(weighted credibility measure)/Sum(credibility measure)=0.25/0.5=0.5. The attribute combiner 212 computes the credibility bump as (Sum(weighted credibility measure)*coeff_credbump)−coeff_credbump. The coeff_credbump is a constant preconfigured in the attribute combiner 212 as 0.1. The coeff_credbump defines the amount of credibility bump to provide to the N sub-lists. The coeff_credbump drives computations performed by the attribute combiner 212, affecting degree of adjustment to be made to the credibility measure. The attribute combiner 212 computes the credibility bump as (0.25*0.1)−0.1=−0.075. The attribute combiner 212 computes the merged credibility measure as (unadjusted credibility measure+credibility bump)=0.5−0.075=0.425˜0.43.

Similarly, the merging module 201 of the need matching system 200 exemplarily illustrated in FIG. 2, creates a sub-list of the item attribute, EXCEL, with corresponding amount present measures 0.90, 0.70, and 0.90 and credibility measures of 0.40, 0.80, and 0.50 as exemplarily illustrated in FIG. 12E. The compute attribute values module 210 determines a weighted amount present measure as attribute amount measure*credibility measure and a weighted credibility measure as credibility measure*credibility measure for each of the occurrences of the item attribute, EXCEL, in the sub-list. The weighted amount present measure is computed as 0.36, 0.56, and 0.45 and the weighted credibility measure is computed as 0.16, 0.64, and 0.25 respectively for the three occurrences of the item attribute, EXCEL, in the sub-list. The attribute combiner 212 computes a merged attribute amount measure as Sum(weighted amount present measure)/Sum(credibility measure). The Sum(weighted amount present measure)=1.37, Sum(credibility measure)=1.70, and Sum(weighted credibility measure)=1.05. The attribute combiner 212 computes the merged attribute amount measure as 1.37/1.7=0.805˜0.81 and the unadjusted credibility measure as Sum(weighted credibility measure)/Sum(credibility measure)=1.05/1.7=0.62. The attribute combiner 212 computes the credibility bump as (Sum(weighted credibility measure)*coeff_credbump)−coeff_credbump with the coeff_credbump as 0.1. The attribute combiner 212 computes the credibility bump as (1.05*0.1)−0.1=0.005. The attribute combiner 212 computes the merged credibility measure as (unadjusted credibility measure+credibility bump)=0.62+0.005=0.625˜0.62.

As exemplarily illustrated in FIG. 12F, a sub-list of 10 reports or occurrences of the item attribute, INTEGRITY, with corresponding amount present measures of 0.50 and corresponding credibility measures of 0.70 is created. The attribute combiner 212 computes a merged attribute amount measure and a merged credibility measure as disclosed in the detailed description of FIGS. 12D-12E, as 0.50 and 1.00 Similarly, in FIG. 12G, a sub-list of 2 reports of the item attribute, PHP, with corresponding amount present measures of 0.50 and credibility measures of 0.70 is created. The attribute combiner 212 computes a merged attribute amount measure and a merged credibility measure as disclosed in the detailed description of FIGS. 12D-12E, as 0.50 and 0.70. As exemplarily illustrated in FIGS. 12F-12G, the item attribute INTEGRITY with 10 reports of the attribute amount measure 0.50 has more merged credibility measure than 2 reports of the item attribute PHP with 2 reports of attribute amount measure 0.50. A credibility bump lowers credibility of few reports of low credibility measures and increases credibility of reports of large credibility measures. The credibility bump is between 0 and 1 and smaller values of credibility bump means more unadjusted credibility measure is needed to get a positive merged credibility measure. For a lower credibility measure, the number of occurrences of the item attribute in the sub-list, that is, rows needed to obtain a positive credibility bump is more for a coeff_credbump=0.1 For a credibility measure of 1.00, 1 report is sufficient to obtain a positive credibility bump. For a credibility measure of 0.8, 2 reports are sufficient to obtain a positive credibility bump. For a credibility measure of 0.6, 3 reports are sufficient to obtain a positive credibility bump. For a credibility measure of 0.4, 10 reports are sufficient to obtain a positive credibility bump. For a credibility measure of 0.2, more than 20 reports are sufficient to obtain a positive credibility bump. For a credibility measure of 0.1, 100 reports are sufficient to obtain a positive credibility bump. The merging module 201 of the need matching system 200 determines the merged attribute amount measure and the merged credibility measure for the remaining item attributes in the first attribute list, exemplarily illustrated in FIG. 12A, as exemplarily illustrated in FIGS. 12F-12I, and creates the unique attribute list as exemplarily illustrated in FIG. 12C.

FIG. 12J exemplarily illustrates a matched attribute list created by the need matching system 200 by matching the unique item attributes in the unique attribute list exemplarily illustrated in FIG. 12C, with the need attributes in the second attribute list exemplarily illustrated in FIG. 12B. The need attribute, DEPENDABILITY, in the second attribute list exemplarily illustrated in FIG. 12B, is absent in the unique attribute list exemplarily illustrated in FIG. 12C. The attribute entry match module 221 exemplarily illustrated in FIG. 7, fetches the need attribute, that is, the attribute needed, from the predefined attribute table in the attribute list database 224 exemplarily illustrated in FIG. 8 and FIG. 12M, along with a corresponding default amount present measure and a default credibility measure. The attribute entry match module 221 inputs the amount present measure and the credibility measure as 0.5 and 0.25 respectively, from the predefined attribute table 224, that is, the attribute list database exemplarily illustrated in FIG. 12M. The need attributes and the item attributes in the predefined attribute table 224 comprise domains of expertise and core traits of the items. The core traits, as exemplarily illustrated in FIG. 12M, are indicated by an ISTRAIT flag. The processing of the item attribute amount measure and the credibility measure for a core trait by the need matching system 200 is the same as the processing of the item attribute amount measure and the credibility measure for a domain of expertise. The core traits have a default amount present measure and a default credibility measure as every item has a core trait to some degree. The item attribute amount measure and the credibility measure of the core traits are not limited to the default amount present measure and the default credibility measure in the predefined attribute table 224. For example, the need attribute “writing attributes” is presumed to be present to a default level in items for which there are no other indications apart from the item attribute amount measure and the credibility measure.

FIG. 12K exemplarily illustrates the matched attribute list exemplarily illustrated in FIG. 12J, comprising attribute match scores generated by the score generation module 203 of the need matching system 200 exemplarily illustrated in FIG. 2, on matching the unique item attributes in the unique attribute list exemplarily illustrated in FIG. 12C, with the need attributes in the second attribute list exemplarily illustrated in FIG. 12B. The need match score generation module 228, exemplarily illustrated in FIG. 15, adds to each matched attribute, additional values of delta and determines the attribute match score, that is, the row match score using an over/under adjustment. The over/under adjustment is a conventional lookup, for example, performed by a VLOOKUP function in MS Excel® of Microsoft Corporation. The over/under adjustment is used for downgrading or penalizing matches with large differences between the unique item attributes and the need attributes. Consider an example of an oral surgeon with 100% dental attributes whose dental attributes are underutilized in a dental hygienist job since the dental hygienist job needs only 10% dental attributes. The oral surgeon may quickly leave the position of a dental hygienist if the oral surgeon finds another position using more of the dental attributes. The need match score generation module 228 fetches an overattributed adjustment from an amount measure deviation lookup table exemplarily illustrated in FIG. 12N, as 0.1 and the row match score is computed to be low, indicating the oral surgeon is not a match for a dental hygienist job. Consider another example of a dental hygienist with 10% dental attributes whose dental attributes are insufficient for a role of an oral surgeon since the role of oral surgeon needs only 100% dental attributes. If placed in the job of an oral surgeon, the dental hygienist may soon be dismissed due to the inability to perform the required job activities of the oral surgeon. The need match score generation module 228 fetches an underattributed adjustment from the amount measure deviation lookup table as 0.1 and the row match score is computed to be low, indicating the dental hygienist is not a match for the role of the oral surgeon. If the item attribute is close to the need attribute, over or under, the over/under adjustments are closer to 1 or equal to 1, making the row match score high between the item attribute and the need attribute as the importance measure of the need attribute and the credibility measure of the item attribute allow.

The need match score generation module 228 computes delta as difference in an attribute amount present measure and an attribute amount needed measure. As exemplarily illustrated in FIG. 12K, the delta for the matched attribute, DEPENDABILITY, is 0.50−0.90=−0.40. The need match score generation module 228 determines an over/under adjustment using a lookup of (delta/attribute amount needed measure) against the amount measure deviation lookup table exemplarily illustrated in FIG. 12N. The value of (delta/attribute amount needed measure)=−0.40/0.90=−0.44˜−0.5. The corresponding over/under adjustment from the amount measure deviation lookup table is 0.6. The need match score generation module 228 computes the attribute match score as (importance measure*credibility measure*over/under adjustment)=0.90*0.25*0.60=0.135˜0.14 as exemplarily illustrated in FIG. 12K. Similarly, for the other matched attributes, the need match score generation module 228 computes the attribute match scores as 0.05, 0.09, and 0.12 for the matched attributes MSWORD, EXCEL, and CONFIDENCE respectively.

FIG. 12L exemplarily illustrates a tabular representation for generation of a need match score defining the degree of match between the item profiles and the need profiles by the final match score generation module 231 exemplarily illustrated in FIG. 9. The final match score generation module 231 calculates a single numerical match score, that is, the need match score, as Sum(attribute match score)/Sum(importance measure)=(0.05+0.09+0.12+0.14)/(0.8+0.3+0.4+0.9)=0.40/2.40=0.1672˜0.17.

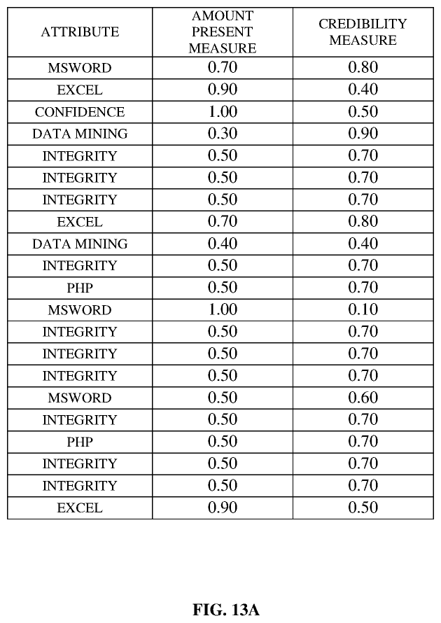

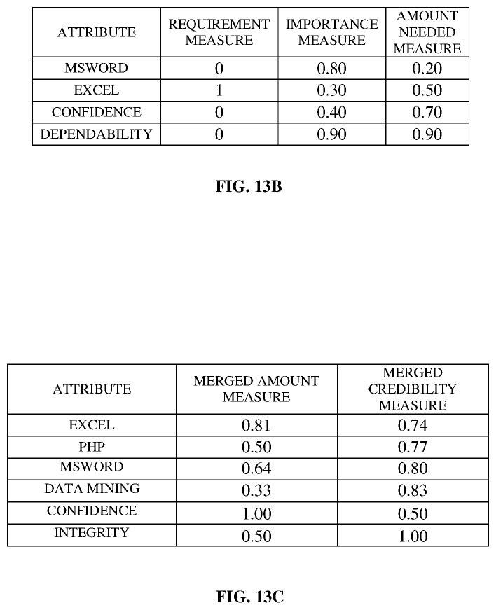

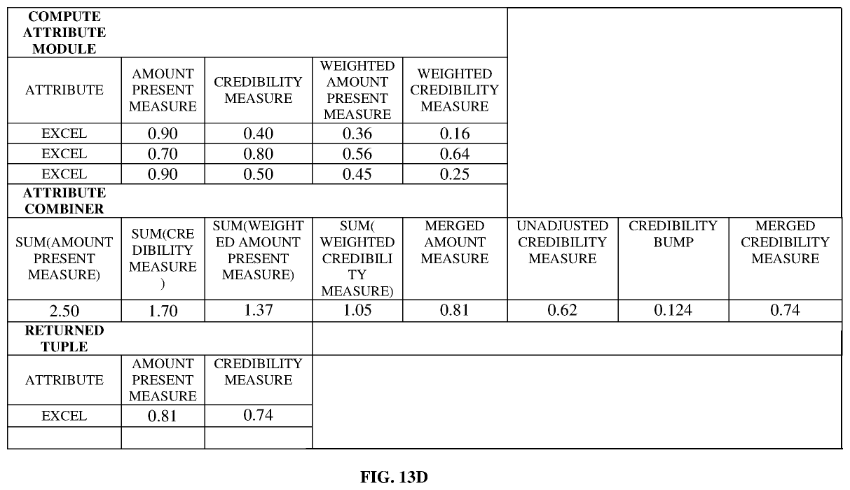

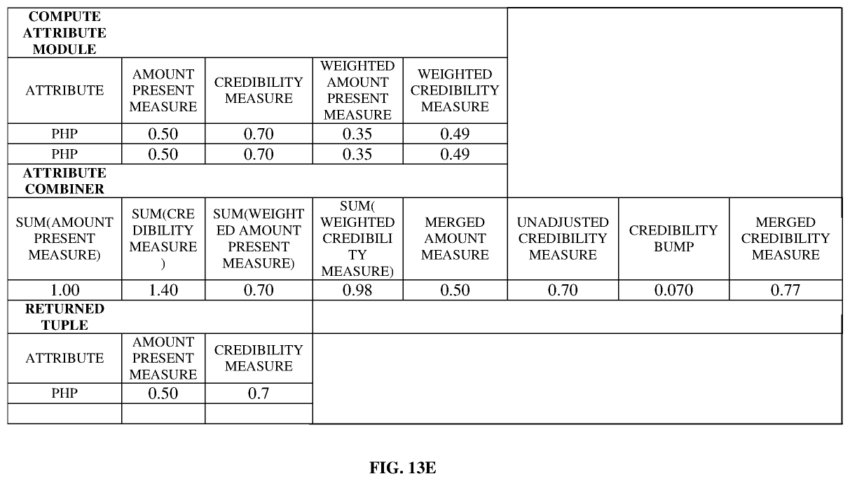

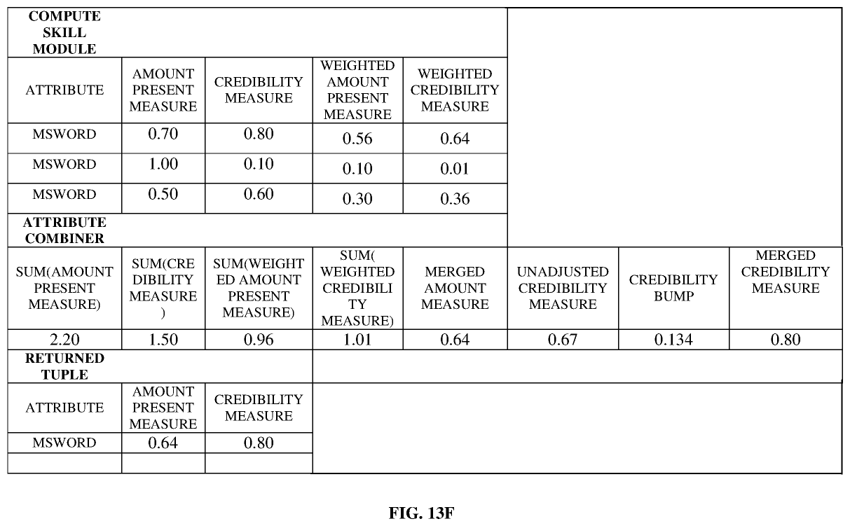

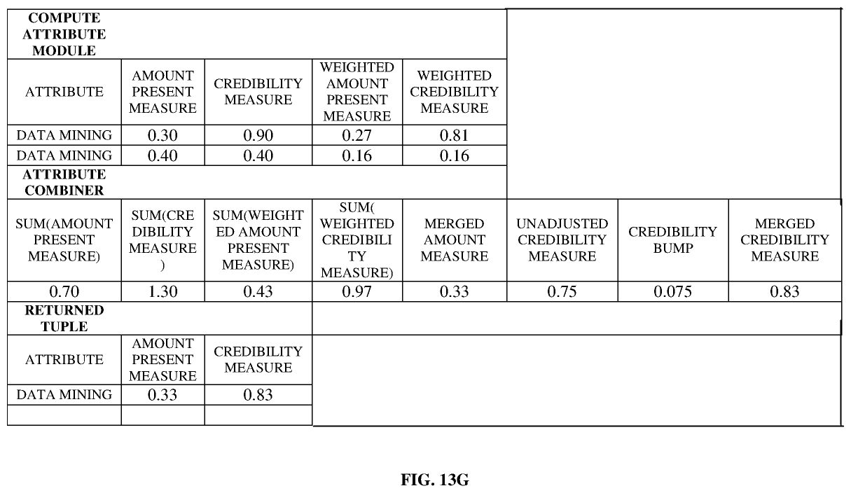

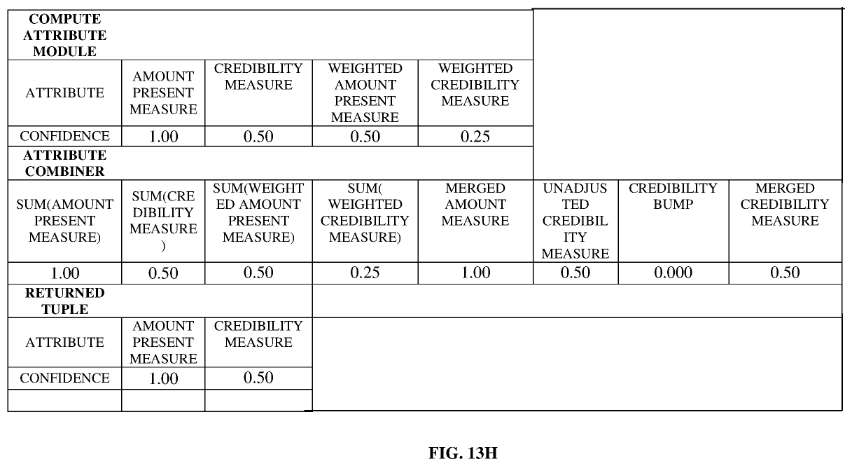

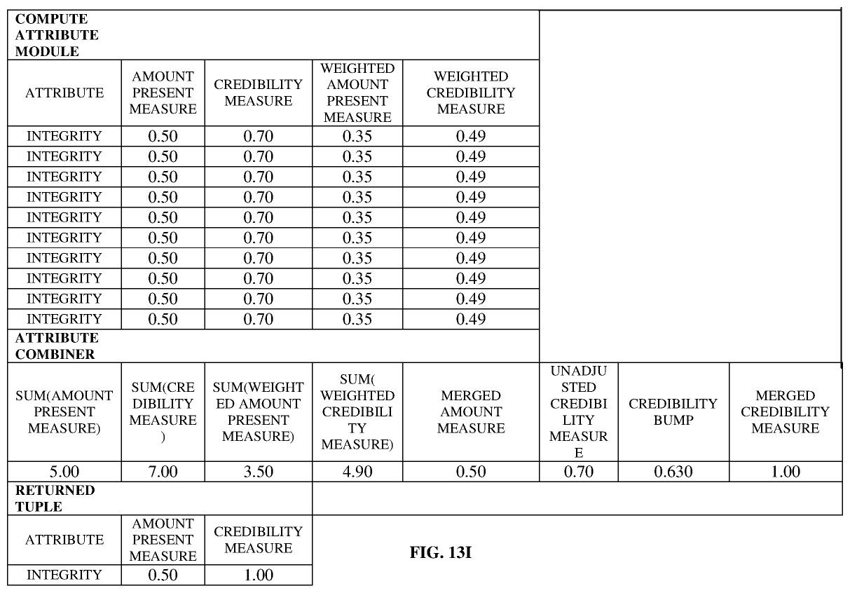

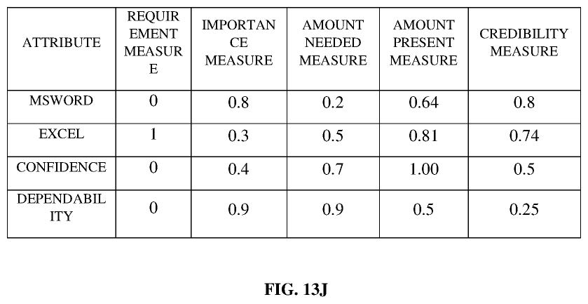

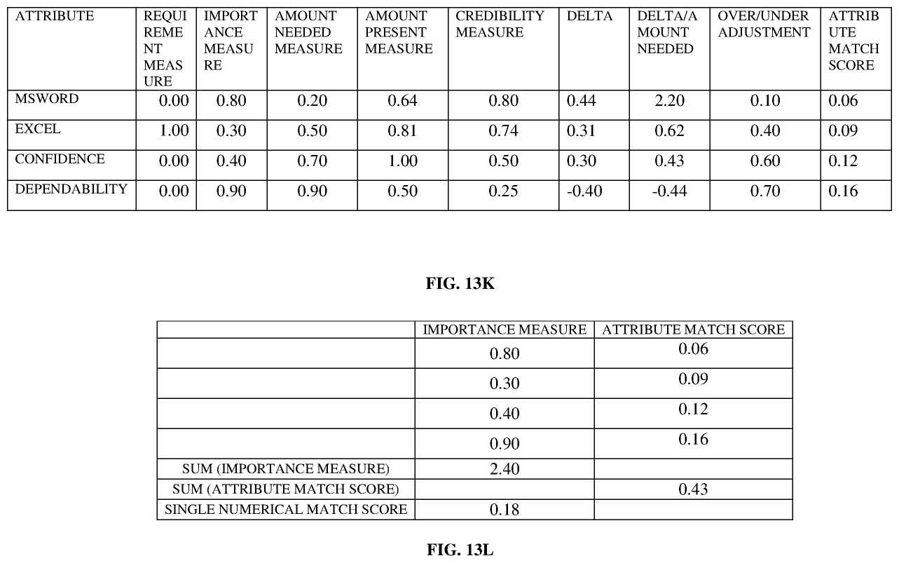

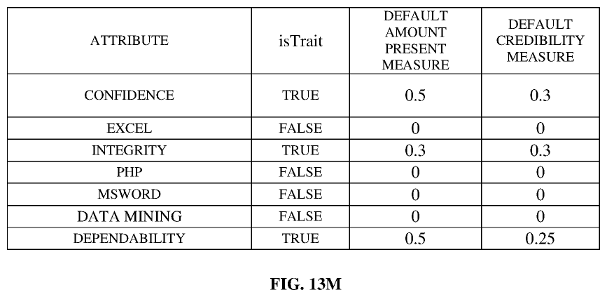

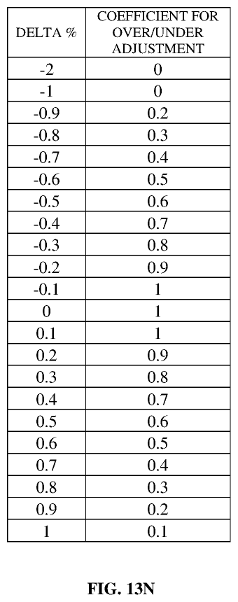

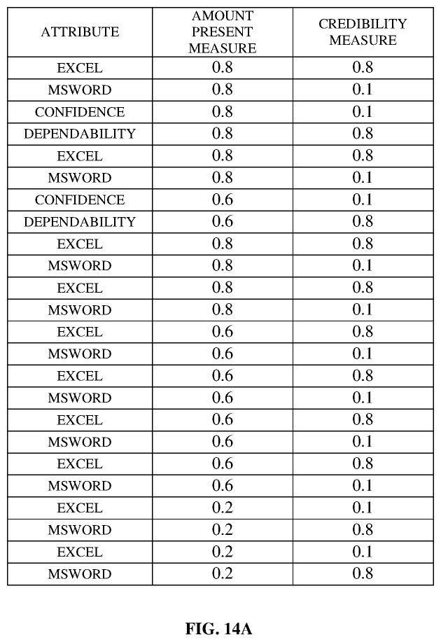

FIGS. 13A-13N exemplarily illustrate another embodiment of tabular representations of computations associated with item attributes and need attributes for determining a degree of match between item profiles with the item attributes with varying ratings of varying credibility and need profiles with the need attributes of varying importance. FIG. 13A exemplarily illustrates a first attribute list comprising item attributes, for example, MS Word, Excel, confidence, data mining, integrity, hypertext preprocessor (PHP) programming language, etc., extracted from item profiles, for example, resumes and reviews of the job seekers. The item attributes, for example, confidence, and integrity are core traits, and the item attributes, for example, MS Word, Excel, PHP programming language, and data mining are domains of expertise of the job seekers. As exemplarily illustrated in FIG. 12A, the first attribute list comprises multiple occurrences of the item attributes in random with corresponding attribute amount measures and corresponding credibility measures. The first attribute list comprises first tuples and each of the first tuples comprises an item attribute, an item attribute amount measure corresponding to the item attribute, and a credibility measure indicating credibility of the item attribute amount measure. As exemplarily illustrated in FIG. 13A, a first tuple in the first attribute list comprises an item attribute, for example, CONFIDENCE, the item attribute amount measure, that is, an amount present measure of 1.00, and a credibility measure of 0.50. Another first tuple in the first attribute list comprises DATA MINING as an item attribute with a corresponding amount present measure of 0.40 and a corresponding credibility measure of 0.40.

FIG. 13B exemplarily illustrates a second attribute list comprising need attributes required for a need. The second attribute list comprises second tuples and each of the second tuples comprises a need attribute, a need attribute amount measure corresponding to the need attribute, a requirement measure, and an importance measure associated with the need attribute. The second attribute list is similar to that of the second attribute list as exemplarily illustrated in the detailed description of FIG. 12B. As exemplarily illustrated in FIG. 13B, a second tuple in the second attribute list comprises a need attribute, for example, CONFIDENCE, a requirement measurement, that is, ISREQ value of NULL, an importance measure of 0.40, and an need attribute amount measure, that is, an amount needed measure of 0.70. Another second tuple comprises, for example, DEPENDABILITY as a need attribute with a corresponding requirement measure of 0, an importance measure of 0.90, and an amount needed measure of 0.90. The need matching system 200 receives the second attribute list exemplarily illustrated in FIG. 13B, from the attribute list database 224, as exemplarily illustrated in FIG. 15.

FIG. 13C exemplarily illustrates a unique attribute list created from the first attribute list exemplarily illustrated in FIG. 13A, by the need matching system 200. As exemplarily illustrated in FIG. 13C, the unique attribute list created from the first attribute list, for example, EXCEL, the item attribute amount measure, that is, an amount present measure of 0.81 and a credibility measure of 0.74. Another example of the unique attribute list created from the first attribute list, for PHP, the item attribute amount measure, that is, an amount present measure of 0.50 and a credibility measure of 0.77.

The need matching system 200 performs merging actions, that is, splitting and sorting of the first tuples of the first attribute list and computes a merged attribute amount measure, that is, the merged amount measure, and a merged credibility measure as exemplarily illustrated in FIGS. 13D-13I. FIGS. 13D-13I exemplarily illustrate 6 sub-lists of the item attributes that are in the first attribute list exemplarily illustrated in FIG. 13A. As exemplarily illustrated in FIG. 13D, the merging module 201 of the need matching system 200 exemplarily illustrated in FIG. 2, creates a sub-list of the item attribute, EXCEL, with a corresponding amount present measure, that is, the item attribute amount measure of 0.90, 0.70, and 0.90 and the corresponding credibility measures of 0.40, 0.80, and 0.50. The compute attribute values module 210 exemplarily illustrated in FIG. 4, determines a weighted amount present measure, that is, a weighted attribute amount measure as attribute amount measure*credibility measure and a weighted credibility measure as credibility measure*credibility measure for each of the occurrences of the item attribute, EXCEL, in the sub-list. The weighted amount present measure is computed as 0.36, 0.56, and 0.45 and the weighted credibility measure is computed as 0.16, 0.64, and 0.25 respectively for the 3 occurrences of the item attribute, EXCEL, in the sublist. The attribute combiner 212 exemplarily illustrated in FIG. 4, computes a merged amount measure, that is, a merged attribute amount measure as Sum(weighted amount present measure)/Sum(credibility measure). Since there are three occurrences of the item attribute EXCEL in the sub-list, the Sum(weighted amount present measure)=1.37, the Sum(credibility measure)=1.70, and the Sum(weighted credibility measure)=1.05. The attribute combiner 212 computes the merged attribute amount measure as 1.37/1.70=0.810 and an unadjusted credibility measure as Sum(weighted credibility measure)/Sum(credibility measure)=1.05/1.70=0.62. The attribute combiner 212 computes the credibility bump as (Count(weighted credibility measure)−1)*unadjusted credibility measure*coeff_credbump with the coeff_credbump as 0.1. The coeff_credbump defines the amount of credibility bump to provide to the N sub-lists. The coeff_credbump drives computations performed by the attribute combiner 212, affecting degree of adjustment to be made to the credibility measure. The attribute combiner 212 computes the credibility bump as (3−1)*0.62*0.1=0.124. The attribute combiner 212 computes the merged credibility measure as (unadjusted credibility measure+credibility bump)=0.62+0.124=0.744−0.74. The merged attribute amount measure of 0.81 is different than 0.83 which is the simple average of the amount present measures of the item attribute, EXCEL.

Similarly, the merging module 201 of the need matching system 200 exemplarily illustrated in FIG. 2, creates a sub-list of the item attribute, PHP, with a corresponding amount present measures 0.50, and 0.50 and a corresponding credibility measures of 0.70, and 0.70 as exemplarily illustrated in FIG. 13E. The compute attribute values module 210 determines a weighted amount present measure as attribute amount measure*credibility measure and a weighted credibility measure as credibility measure*credibility measure for each of the occurrences of the item attribute, PHP, in the sub-list. The weighted amount present measure is computed as 0.35 and 0.35, and the weighted credibility measure is computed as 0.49 and 0.49, respectively for the two occurrences of the item attribute, PHP, in the sublist. The attribute combiner 212 computes a merged attribute amount measure as the Sum(weighted amount present measure)/Sum(credibility measure). The Sum(weighted amount present measure)=0.70, the Sum(credibility measure)=1.40, and the Sum(weighted credibility measure)=0.98. The attribute combiner 212 computes the merged attribute amount measure as 0.70/1.40=0.500 and the unadjusted credibility measure as the Sum(weighted credibility measure)/Sum(credibility measure)=0.98/1.40=0.70. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (2−1)*0.70*0.1=0.070. The attribute combiner 212 computes the merged credibility measure as (unadjusted credibility measure+credibility bump)=0.70+0.070=0.77.

Similarly, the merging module 201 of the need matching system 200 exemplarily illustrated in FIG. 2, creates a sub-list of the item attribute, MSWORD, with a corresponding amount present measures 0.70, 1.00, and 0.50 and a corresponding credibility measures of 0.80, 0.10, and 0.60 as exemplarily illustrated in FIG. 13F. The compute attribute values module 210 determines a weighted amount present measure as attribute amount measure*credibility measure and a weighted credibility measure as credibility measure*credibility measure for each of the occurrences of the item attribute, MSWORD, in the sub-list. The weighted amount present measure is computed as 0.56, 0.10, and 0.30 and the weighted credibility measure is computed as 0.64, 0.01, and 0.36 respectively for the 3 occurrences of the item attribute, MSWORD, in the sublist. The attribute combiner 212 computes a merged attribute amount measure as the Sum(weighted amount present measure)/Sum(credibility measure). The Sum(weighted amount present measure)=0.96, the Sum(credibility measure)=1.50, and the Sum(weighted credibility measure)=1.01. The attribute combiner 212 computes the merged attribute amount measure as 0.96/1.50=0.640 and the unadjusted credibility measure as the Sum(weighted credibility measure)/Sum(credibility measure)=1.01/1.50=0.67. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (3−1)*0.67*0.1=0.134. The attribute combiner 212 computes the merged credibility measure as (unadjusted credibility measure+credibility bump)=0.67+0.134=0.804−0.80. The merged attribute amount measure of 0.64 is different than 0.73 which is the simple average of the amount present measures.

Similarly, the merging module 201 of the need matching system 200 exemplarily illustrated in FIG. 2, creates a sub-list of the item attribute, DATA MINING, with a corresponding amount present measures 0.30, and 0.40 and a corresponding credibility measures of 0.90, and 0.40 as exemplarily illustrated in FIG. 13G. The compute attribute values module 210 determines a weighted amount present measure as attribute amount measure*credibility measure and a weighted credibility measure as credibility measure*credibility measure for each of the occurrences of the item attribute, DATA MINING, in the sub-list. The weighted amount present measure is computed as 0.27, and 0.16 and the weighted credibility measure is computed as 0.81, and 0.16 respectively for the 2 occurrences of the item attribute, DATA MINING, in the sublist. The attribute combiner 212 computes a merged attribute amount measure as the Sum(weighted amount present measure)/Sum(credibility measure). The Sum(weighted amount present measure)=0.43, the Sum(credibility measure)=1.30, and the Sum(weighted credibility measure)=0.97. The attribute combiner 212 computes the merged attribute amount measure as 0.43/1.30=0.330 and the unadjusted credibility measure as the Sum(weighted credibility measure)/Sum(credibility measure)=0.97/1.30=0.75. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (2−1)*0.75*0.1=0.075. The attribute combiner 212 computes the merged credibility measure as (unadjusted credibility measure+credibility bump)=0.75+0.075=0.825˜0.83. The merged attribute amount measure of 0.33 is different than 0.35 which is the simple average of the amount present measures.

Similarly, the merging module 201 of the need matching system 200 exemplarily illustrated in FIG. 2, creates a sub-list of the item attribute, CONFIDENCE, with a corresponding amount present measure 1.00 and a corresponding credibility measure of 0.50 as exemplarily illustrated in FIG. 13H. The compute attribute values module 210 determines a weighted amount present measure as attribute amount measure*credibility measure and a weighted credibility measure as credibility measure*credibility measure for each of the occurrences of the item attribute, CONFIDENCE, in the sub-list. The weighted amount present measure is computed as 0.50 and the weighted credibility measure is computed as 0.25, respectively for only one occurrence of the item attribute, CONFIDENCE, in the sublist. The attribute combiner 212 computes a merged attribute amount measure as the Sum(weighted amount present measure)/Sum(credibility measure). The Sum(weighted amount present measure)=0.50, the Sum(credibility measure)=0.50, and the Sum(weighted credibility measure)=0.25. The attribute combiner 212 computes the merged attribute amount measure as 0.50/0.50=1.000 and the unadjusted credibility measure as the Sum(weighted credibility measure)/Sum(credibility measure)=0.25/0.50=0.50. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (1−1)*0.50*0.1=0.000. The attribute combiner 212 computes the merged credibility measure as (unadjusted credibility measure+credibility bump)=0.50+0.000=0.50.

Similarly, the merging module 201 of the need matching system 200 exemplarily illustrated in FIG. 2, creates a sub-list of the item attribute, INTEGRITY, with a corresponding amount present measures 0.50, 0.50, 0.50, 0.50, 0.50, 0.50, 0.50, 0.50, 0.50, and 0.50 and a corresponding credibility measures of 0.70, 0.70, 0.70, 0.70, 0.70, 0.70, 0.70, 0.70, 0.70, and 0.70 as exemplarily illustrated in FIG. 131. The compute attribute values module 210 determines a weighted amount present measure as attribute amount measure*credibility measure and a weighted credibility measure as credibility measure*credibility measure for each of the occurrences of the item attribute, INTEGRITY, in the sub-list. The weighted amount present measure is computed as 0.35, 0.35, 0.35, 0.35, 0.35, 0.35, 0.35, 0.35, 0.35, and 0.35 and the weighted credibility measure is computed as 0.49, 0.49, 0.49, 0.49, 0.49, 0.49, 0.49, 0.49, 0.49, and 0.49 respectively for the ten occurrences of the item attribute, INTEGRITY, in the sublist. The attribute combiner 212 computes a merged attribute amount measure as the Sum(weighted amount present measure)/Sum(credibility measure). The Sum(weighted amount present measure)=3.50, the Sum(credibility measure)=7.00, and the Sum(weighted credibility measure)=4.90. The attribute combiner 212 computes the merged attribute amount measure as 3.50/7.00=0.500 and the unadjusted credibility measure as the Sum(weighted credibility measure)/Sum(credibility measure)=4.90/7.00=0.70. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (10−1)*0.70*0.1=0.630. The attribute combiner 212 computes the merged credibility measure as (unadjusted credibility measure+credibility bump)=0.70+0.630=1.33. The merged credibility measure is adjusted to have a maximum value of 1.

FIG. 13J exemplarily illustrates a matched attribute list created by the need matching system 200 by matching the unique item attributes in the unique attribute list exemplarily illustrated in FIG. 13C, with the need attributes in the second attribute list exemplarily illustrated in FIG. 13B. The need attribute, DEPENDABILITY, in the second attribute list exemplarily illustrated in FIG. 13B, is absent in the unique attribute list exemplarily illustrated in FIG. 13C. The attribute entry matching module 221 creates an attribute present entry with the amount present measure and the credibility measure as 0.64 and 0.8 respectively for MSWORD, from the predefined attribute table, that is, the attribute list database 224, as exemplarily illustrated in FIG. 13M. Similarly, the corresponding amount present measure and the corresponding credibility measure for EXCEL are 0.81 and 0.74 respectively as exemplarily illustrated in FIG. 13J.

FIG. 13K exemplarily illustrates the matched attribute list exemplarily illustrated in FIG. 13J, comprising attribute match scores generated by the score generation module 203 of the need matching system 200 exemplarily illustrated in FIG. 2, on matching the unique item attributes in the unique attribute list exemplarily illustrated in FIG. 13C, with the need attributes in the second attribute list exemplarily illustrated in FIG. 13B. The need match score generation module 228, exemplarily illustrated in FIG. 9, computes delta as difference in an attribute amount present measure and a attribute amount needed measure. As exemplarily illustrated in FIG. 13K, the delta for the matched attribute, MSWORD, is 0.64−0.20=0.44. The need match score generation module 228 determines an over/under adjustment using a lookup of (delta/attribute amount needed measure) against the amount measure deviation lookup table exemplarily illustrated in FIG. 13N. The value of (delta/attribute amount needed measure)=0.44/0.20=2.20. The corresponding over/under adjustment from the amount measure deviation lookup table is 0.10. The need match score generation module 228 computes the attribute match score as (importance measure* credibility measure* over/under adjustment)=0.80*0.80*0.10=0.064˜0.06 as exemplarily illustrated in FIG. 13K. Similarly, for the other matched attributes, the need match score generation module 228 computes the attribute match scores as 0.09, 0.12, and 0.16 for the matched attributes EXCEL, CONFIDENCE, and DEPENDABILITY, respectively.

FIG. 13L exemplarily illustrates a tabular representation for generation of an need match score defining the degree of match between the item profiles and the need profiles by the final match score generation module 231 exemplarily illustrated in FIG. 9. The final match score generation module 231 calculates a single numerical match score, that is, the need match score, as the Sum(attribute match score)/Sum(importance measure)=(0.06+0.09+0.12+0.16)/(0.80+0.30+0.40+0.90)=0.43/2.40=0.1796˜0.18. The single numerical match score of 0.180 is different than 0.108 which is the simple average of the attribute match score without using importance as a weight.

FIG. 13M exemplarily illustrates a tabular representation of the default amount preset measure and the default credibility measure. For example, for the item attribute of CONFIDENCE, if the isTrait representation is TRUE, the default amount measure is 0.5 and the corresponding credibility measure is 0.3. For the item attribute of PHP, if the isTrait representation is FALSE, the default amount measure and the corresponding credibility measure are 0.

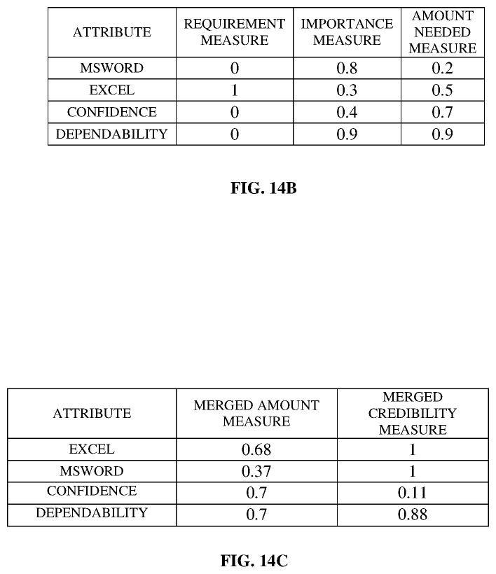

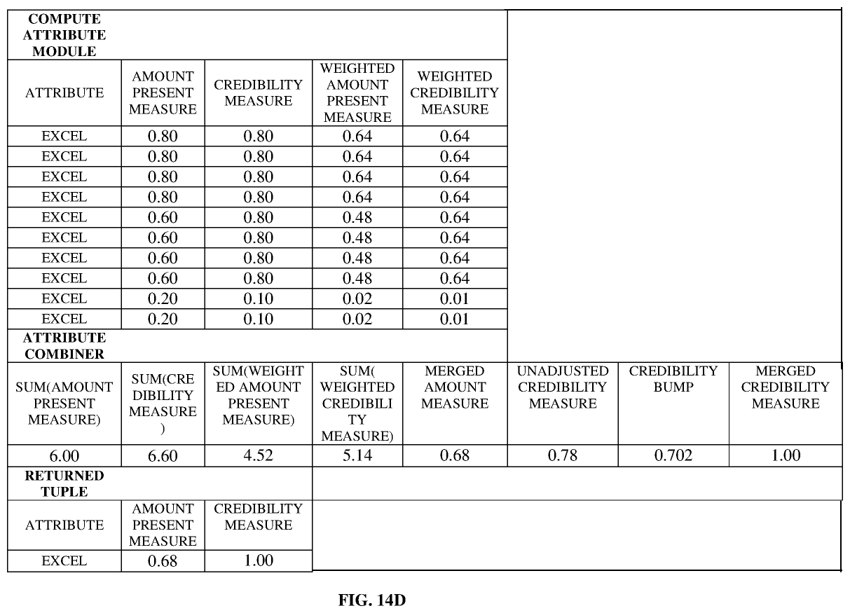

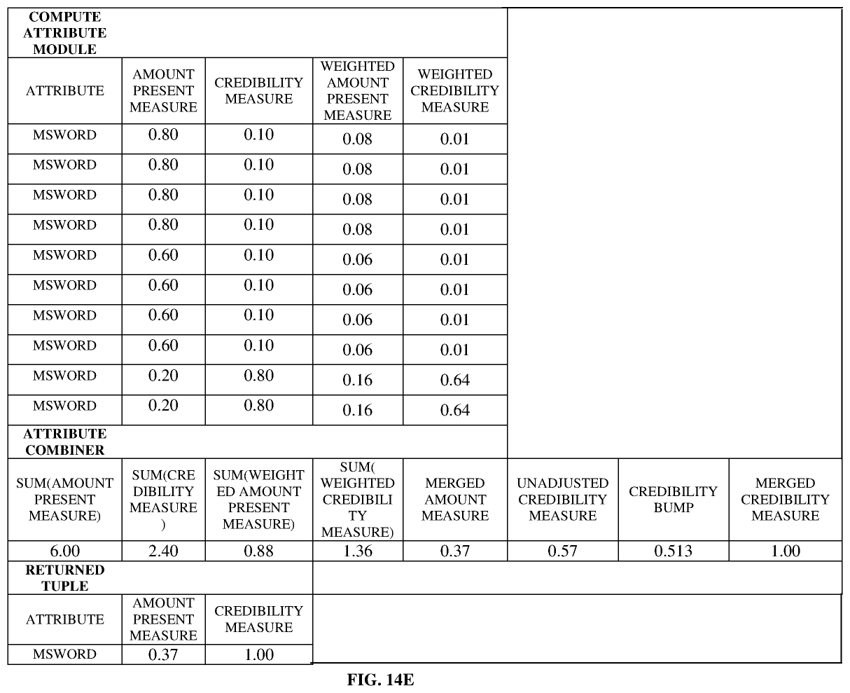

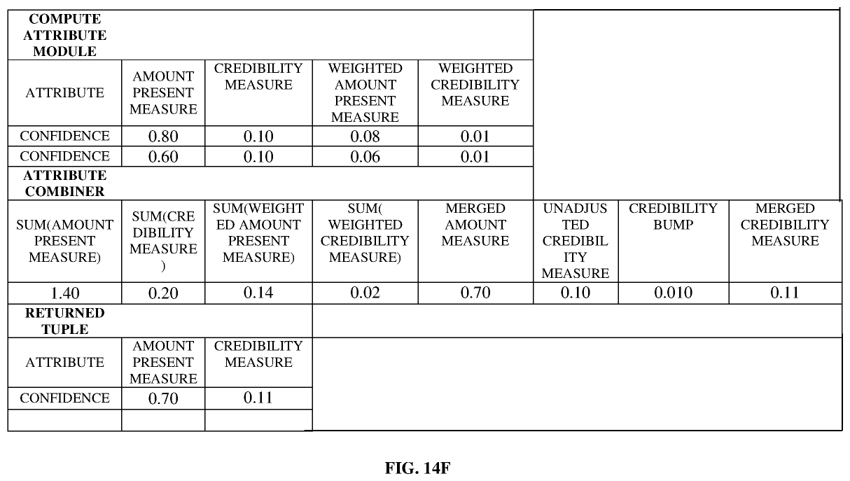

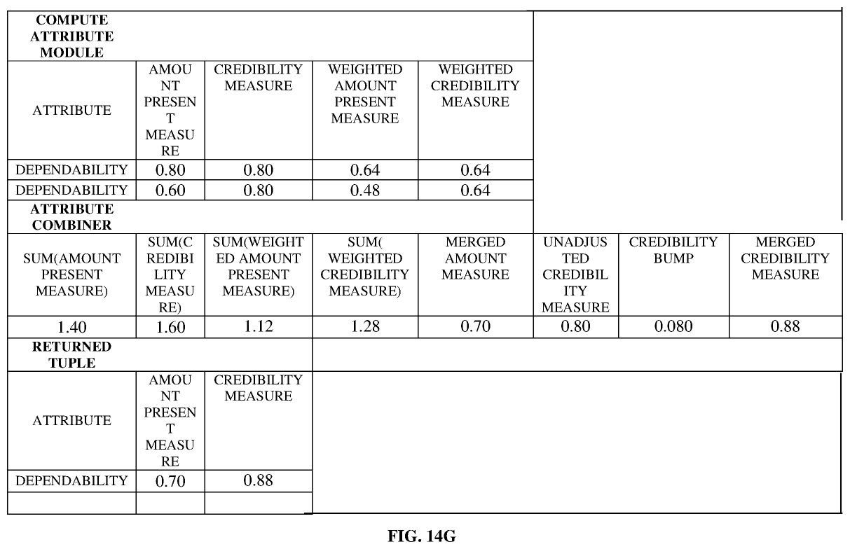

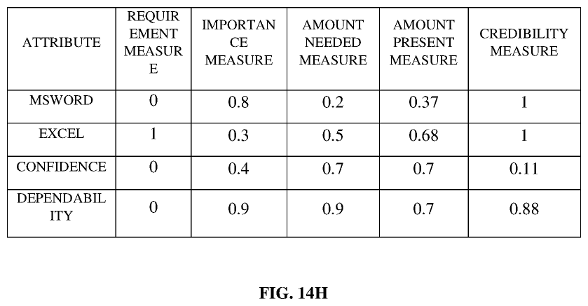

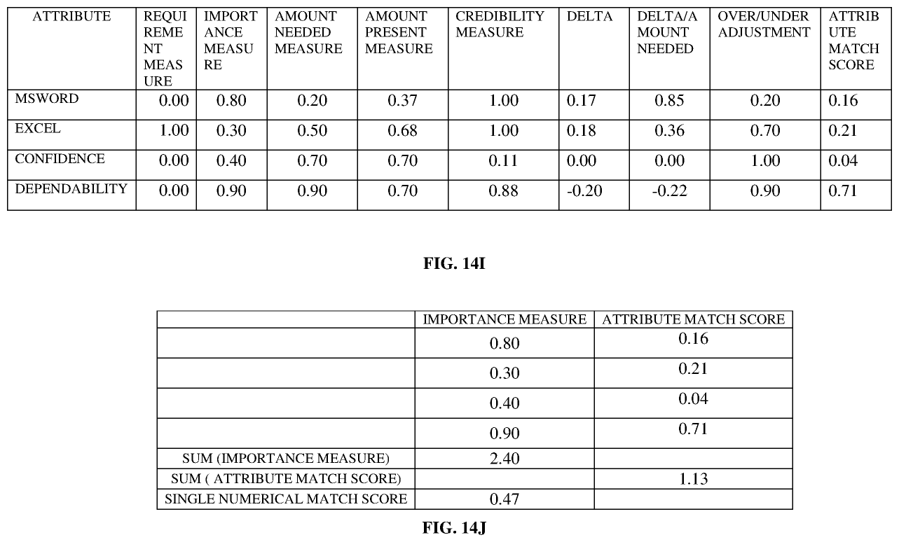

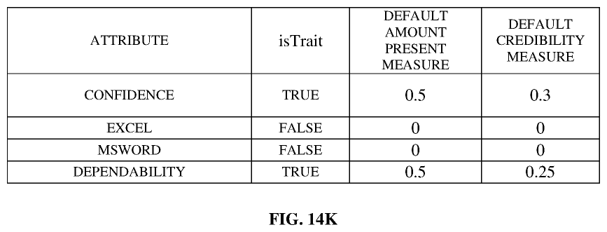

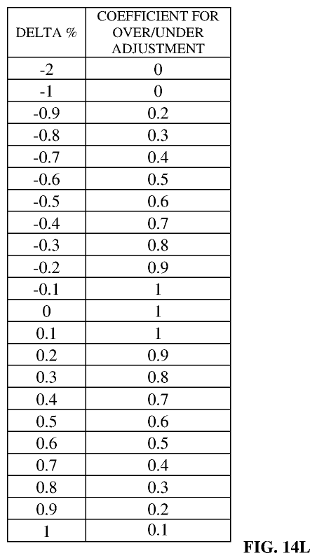

FIGS. 14A-14N exemplarily illustrate another embodiment of tabular representations of computations associated with item attributes and need attributes for determining a degree of match between item profiles with the item attributes of varying credibility and needs with the need attributes of varying importance. FIG. 14A exemplarily illustrates a first attribute list comprising item attributes, for example, MS Word, Excel, confidence, and dependability, extracted from item profiles, for example, resumes and reviews of the job seekers. As exemplarily illustrated in FIG. 14A, the first attribute list comprises multiple occurrences of the item attributes in random with corresponding attribute amount measures and corresponding credibility measures. The need matching system 200 receives the first attribute list exemplarily illustrated in FIG. 12A, FIG. 13A, and FIG. 14A comprising the item attributes from an attribute list database 224. The first attribute list comprises first tuples and each of the first tuples comprises an item attribute, an item attribute amount measure corresponding to the item attribute, and a credibility measure indicating credibility of the item attribute amount measure as exemplarily illustrated in the detailed description of FIG. 12A, FIG. 13A, and FIG. 14A. As exemplarily illustrated in FIG. 14A, a first tuple in the first attribute list comprises an item attribute, for example, EXCEL, the item attribute amount measure, that is, an amount present measure of 0.8, and a credibility measure of 0.8. Another first tuple in the first attribute list comprises MSWORD as an item attribute with a corresponding amount present measure of 0.8 and a corresponding credibility measure of 0.1.

FIG. 14B exemplarily illustrates a second attribute list comprising need attributes required for a need. The second attribute list comprises second tuples and each of the second tuples comprises an need attribute, an need attribute amount measure corresponding to the need attribute, a requirement measure, and an importance measure associated with the need attribute. The second attribute list is similar to that of the second attribute list as exemplarily illustrated in the detailed description of FIG. 12B and FIG. 13B. As exemplarily illustrated in FIG. 14B, a second tuple in the second attribute list comprises an need attribute, for example, MSWORD, a requirement measurement, that is, ISREQ value of NULL, an importance measure of 0.8, and an need attribute amount measure, that is, an amount needed measure of 0.20. Another second tuple comprises, for example, EXCEL as an need attribute with a corresponding requirement measure of 1, an importance measure of 0.30, and an amount needed measure of 0.50. The need matching system 200 receives the second attribute list exemplarily illustrated in FIG. 12B, FIG. 13B, and FIG. 14B from the attribute list database 224.

FIG. 14C exemplarily illustrates a unique attribute list created from the first attribute list exemplarily illustrated in FIG. 14A, by the need matching system 200. As exemplarily illustrated in FIG. 14C, the unique attribute list created from the first attribute list, for example, EXCEL, the item attribute amount measure, that is, an amount present measure of 0.68 and a credibility measure of 1. Another example of the unique attribute list created from the first attribute list, for MSWORD, the item attribute amount measure, that is, an amount present measure of 0.37 and a credibility measure of 1.

The need matching system 200 performs merging actions, that is, splitting and sorting of the first tuples of the first attribute list and computes a merged attribute amount measure, that is, the merged amount measure, and a merged credibility measure as exemplarily illustrated in FIGS. 14D-14G. FIGS. 14D-14G exemplarily illustrate 4 sub-lists of the item attributes that are in the first attribute list exemplarily illustrated in FIG. 14A. As exemplarily illustrated in FIG. 14D, the merging module 201 of the need matching system 200 exemplarily illustrated in FIG. 2, creates a sub-list of the item attribute, EXCEL, with a corresponding amount present measures 0.80, 0.80, 0.80, 0.80, 0.60, 0.60, 0.60, 0.60, 0.20, and 0.20 and a corresponding credibility measures of 0.80, 0.80, 0.80, 0.80, 0.80, 0.80, 0.80, 0.80, 0.10, and 0.10 as exemplarily illustrated in FIG. 14D. The compute attribute values module 210 determines a weighted amount present measure as attribute amount measure*credibility measure and a weighted credibility measure as credibility measure*credibility measure for each of the occurrences of the item attribute, EXCEL, in the sub-list. The weighted amount present measure is computed as 0.64, 0.64, 0.64, 0.64, 0.48, 0.48, 0.48, 0.48, 0.02, and 0.02 and the weighted credibility measure is computed as 0.64, 0.64, 0.64, 0.64, 0.64, 0.64, 0.64, 0.64, 0.01, and 0.01 respectively for the 10 occurrences of the item attribute, EXCEL, in the sublist. The attribute combiner 212 computes a merged attribute amount measure as the Sum(weighted amount present measure)/Sum(credibility measure). The Sum(weighted amount present measure)=4.52, the Sum(credibility measure)=6.60, and the Sum(weighted credibility measure)=5.14. The attribute combiner 212 computes the merged attribute amount measure as 4.52/6.60=0.680 and the unadjusted credibility measure as the Sum(weighted credibility measure)/Sum(credibility measure)=5.14/6.60=0.78. The attribute combiner 212 computes the credibility bump as (Count(weighted credibility measure)−1)*unadjusted credibility measure*coeff_credbump with the coeff_credbump as 0.1. The coeff_credbump defines the amount of credibility bump to provide to the N sub-lists. The coeff_credbump drives computations performed by the attribute combiner 212, affecting degree of adjustment to be made to the credibility measure. The attribute combiner 212 computes the credibility bump as (10−1)*0.78*0.1=0.702. The attribute combiner 212 computes the merged credibility measure as (unadjusted credibility measure+credibility bump)=0.78+0.702=1.482˜1.48. The merged credibility measure is adjusted to have a maximum value of 1. The merged attribute amount measure of 0.68 is different than 0.60 which is the simple average of the amount present measures.

Similarly, the merging module 201 of the need matching system 200 exemplarily illustrated in FIG. 2, creates a sub-list of the item attribute, MSWORD, with a corresponding amount present measures 0.80, 0.80, 0.80, 0.80, 0.60, 0.60, 0.60, 0.60, 0.20, and 0.20 and a corresponding credibility measures of 0.10, 0.10, 0.10, 0.10, 0.10, 0.10, 0.10, 0.10, 0.80, and 0.80 as exemplarily illustrated in FIG. 14E. The compute attribute values module 210 determines a weighted amount present measure as attribute amount measure*credibility measure and a weighted credibility measure as credibility measure*credibility measure for each of the occurrences of the item attribute, MSWORD, in the sub-list. The weighted amount present measure is computed as 0.08, 0.08, 0.08, 0.08, 0.06, 0.06, 0.06, 0.06, 0.16, and 0.16 and the weighted credibility measure is computed as 0.01, 0.01, 0.01, 0.01, 0.01, 0.01, 0.01, 0.01, 0.64, and 0.64 respectively for the 10 occurrences of the item attribute, MSWORD, in the sublist. The attribute combiner 212 computes a merged attribute amount measure as the Sum(weighted amount present measure)/Sum(credibility measure). The Sum(weighted amount present measure)=0.88, the Sum(credibility measure)=2.40, and the Sum(weighted credibility measure)=1.36. The attribute combiner 212 computes the merged attribute amount measure as 0.88/2.40=0.370 and the unadjusted credibility measure as the Sum(weighted credibility measure)/Sum(credibility measure)=1.36/2.40=0.57. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (10−1)*0.57*0.1=0.513. The attribute combiner 212 computes the merged credibility measure as (unadjusted credibility measure+credibility bump)=0.57+0.513=1.083˜4.08. The merged credibility measure is adjusted to have a maximum value of 1. The merged attribute amount measure of 0.37 is different than 0.60 which is the simple average of the amount present measures.

Similarly, the merging module 201 of the need matching system 200 exemplarily illustrated in FIG. 2, creates a sub-list of the item attribute, CONFIDENCE, with a corresponding amount present measures 0.80, and 0.60 and a corresponding credibility measures of 0.10, and 0.10 as exemplarily illustrated in FIG. 14F. The compute attribute values module 210 determines a weighted amount present measure as attribute amount measure*credibility measure and a weighted credibility measure as credibility measure*credibility measure for each of the occurrences of the item attribute, CONFIDENCE, in the sub-list. The weighted amount present measure is computed as 0.08, and 0.06 and the weighted credibility measure is computed as 0.01, and 0.01 respectively for the 2 occurrences of the item attribute, CONFIDENCE, in the sublist. The attribute combiner 212 computes a merged attribute amount measure as the Sum(weighted amount present measure)/Sum(credibility measure). The Sum(weighted amount present measure)=0.14, the Sum(credibility measure)=0.20, and the Sum(weighted credibility measure)=0.02. The attribute combiner 212 computes the merged attribute amount measure as 0.14/0.20=0.700 and the unadjusted credibility measure as the Sum(weighted credibility measure)/Sum(credibility measure)=0.02/0.20=0.10. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (2−1)*0.10*0.1=0.010. The attribute combiner 212 computes the merged credibility measure as (unadjusted credibility measure+credibility bump)=0.10+0.010=0.11.

Similarly, the merging module 201 of the need matching system 200 exemplarily illustrated in FIG. 2, creates a sub-list of the item attribute, DEPENDABILITY, with the corresponding amount present measures 0.80, and 0.60 and the corresponding credibility measures of 0.80, and 0.80 as exemplarily illustrated in FIG. 14G. The compute attribute values module 210 determines a weighted amount present measure as attribute amount measure*credibility measure and a weighted credibility measure as credibility measure*credibility measure for each of the occurrences of the item attribute, DEPENDABILITY, in the sub-list. The weighted amount present measure is computed as 0.64, and 0.48 and the weighted credibility measure is computed as 0.64, and 0.64 respectively for the 2 occurrences of the item attribute, DEPENDABILITY, in the sublist. The attribute combiner 212 computes a merged attribute amount measure as the Sum(weighted amount present measure)/Sum(credibility measure). The Sum(weighted amount present measure)=1.12, the Sum(credibility measure)=1.60, and the Sum(weighted credibility measure)=1.28. The attribute combiner 212 computes the merged attribute amount measure as 1.12/1.60=0.700 and the unadjusted credibility measure as the Sum(weighted credibility measure)/Sum(credibility measure)=1.28/1.60=0.80. The attribute combiner 212 computes the credibility bump as (Count(weighted credibility measure)−1)*unadjusted credibility measure*coeff_credbump with the coeff_credbump as 0.1. The attribute combiner 212 computes the credibility bump as (2−1)*0.80*0.1=0.080. The attribute combiner 212 computes the merged credibility measure as (unadjusted credibility measure+credibility bump)=0.80+0.080=0.88.

FIG. 14H exemplarily illustrates a matched attribute list created by the need matching system 200 by matching the unique item attributes in the unique attribute list exemplarily illustrated in FIG. 14C, with the need attributes in the second attribute list exemplarily illustrated in FIG. 14B. The attribute entry matching module 221 creates a attribute present entry with the amount present measure and the credibility measure as 0.37 and 1 respectively for MSWORD, from the predefined attribute table 224, that is, the attribute list database exemplarily illustrated in FIG. 14K. Similarly, the corresponding amount present measure and the corresponding credibility measure for EXCEL are 0.68 and 1 respectively as exemplarily illustrated in FIG. 14H.

FIG. 14I exemplarily illustrates the matched attribute list exemplarily illustrated in FIG. 14H, comprising attribute match scores generated by the score generation module 203 of the need matching system 200 exemplarily illustrated in FIG. 2, on matching the unique item attributes in the unique attribute list exemplarily illustrated in FIG. 14C, with the need attributes in the second attribute list exemplarily illustrated in FIG. 14B. The need match score generation module 228, exemplarily illustrated in FIG. 9, computes delta as difference in a attribute amount present measure and a attribute amount needed measure. As exemplarily illustrated in FIG. 14I, the delta for the matched attribute, MSWORD, is 0.37−0.20=0.17. The need match score generation module 228 determines an over/under adjustment using a lookup of (delta/attribute amount needed measure) against the amount measure deviation lookup table exemplarily illustrated in FIG. 14L. The value of (delta/attribute amount needed measure)=0.17/0.20=0.85. The corresponding over/under adjustment from the amount measure deviation lookup table is 0.20. The need match score generation module 228 computes the attribute match score as (importance measure*credibility measure*over/under adjustment)=0.80*1.00*0.20=0.16 as exemplarily illustrated in FIG. 14I. Similarly, for the other matched attributes, the need match score generation module 228 computes the attribute match scores as 0.21, 0.04, and 0.71 for the matched attributes EXCEL, CONFIDENCE, and DEPENDABILITY respectively.

FIG. 14J exemplarily illustrates a tabular representation for generation of a need match score defining the degree of match between the item profiles and the needs by the final match score generation module 231 exemplarily illustrated in FIG. 9. The final match score generation module 231 calculates a single numerical match score, that is, the need match score, as the Sum(attribute match score)/Sum(importance measure)=(0.16+0.21+0.04+0.71)/(0.80+0.30+0.40+0.90)=1.13/2.40=0.4696˜0.47. The single numerical match score of 0.470 is different than 0.282 which is the simple average of the attribute match score without using importance as a weight.

FIG. 14K exemplarily illustrates a tabular representation of the default amount preset measure and the default credibility measure. For example, the item attribute of CONFIDENCE, if the isTrait representation is TRUE, the default amount measure is 0.5 and the corresponding credibility measure is 0.3. The item attribute of DEPENDABILITY, if the isTrait representation is TRUE, the default amount measure is 0.5 and the corresponding credibility measure is 0.25.

As exemplarily illustrated in the detailed description of FIGS. 14A-14L, for example, the need matching system 200 identifies EXCEL with 10 ratings and 2 of which are outliers. The item attribute with 8 ratings is considered to be of high credibility and the outliers are considered to be of low credibility. The amount present measure is 0.68 and is very close to the 8 ratings. The low credibility outliers have minimum effect. In another example, the need matching system 200 identifies MSWORD with 10 ratings and 2 of which are outliers. The item attributes with 8 ratings are considered to be of low credibility and the outliers are considered to be of high credibility. The amount present measure is 0.37 and is very close to the 2 high credibility outliers. In another example, the need matching system 200 identifies DEPENABILITY with 2 high credibility ratings. The amount present measure is midway between the two with higher credibility than either of the 2 ratings. In another example, the need matching system 200 identifies, CONFIDENCE with 2 low credibility ratings. The amount present measure is midway between the two and the same as for INTEGRITY, with higher credibility than either of the 2 ratings but much lower than that of INTEGRITY. The credibility of the individual ratings is based on the aggregated amount present measure. The outliers can be nearly ignored or very significant depending on their credibility. The credibility does not affect the amount present measure but affects the aggregated credibility which in turn affects the attribute match score.

FIG. 15 exemplarily illustrates a computer implemented system 1500 comprising the need matching system 200 for determining a degree of match between item profiles with item attributes of varying credibility and needs with need attributes of varying importance. The need matching system 200 is a computer system that is programmable using a high level computer programming language. In an embodiment, the need matching system 200 uses programmed and purposeful hardware. The need matching system 200 is implemented on a computing device, for example, a personal computer, a tablet computing device, a mobile computer, a portable computing device, a laptop, a touch device, a workstation, a server, portable electronic device, a network enabled computing device, an interactive network enabled communication device, any other suitable computing equipment, combinations of multiple pieces of computing equipment, etc. In an embodiment, the computing equipment is used to implement applications such as media playback applications, a web browser, an electronic mail (email) application, a calendar application, etc. In another embodiment, the computing equipment, for example, one or more servers are associated with one or more online services. In an embodiment, the need matching system 200 is configured as a web based platform, for example, a website hosted on a server or a network of servers.

The need matching system 200 communicates with user devices 1502 via the network 1501, for example, a short range network or a long range network. The user devices 1502 comprising 1502a, 1502b, are electronic devices, for example, personal computers, tablet computing devices, mobile computers, mobile phones, smartphones, portable computing devices, personal digital assistants, laptops, wearable computing devices such as the Google Glass® of Google Inc., the Apple Watch® of Apple Inc., etc., touch centric devices, client devices, portable electronic devices, network enabled computing devices, interactive network enabled communication devices, any other suitable computing equipment, combinations of multiple pieces of computing equipment, etc. In an embodiment, the user devices 1502a and 1502b are hybrid computing devices that combine the functionality of multiple devices. Examples of a hybrid computing device comprise a cellular telephone that includes a media player functionality, a gaming device that includes a wireless communications capability, a cellular telephone that includes a document reader and multimedia functions, and a portable device that has network browsing, document rendering, and network communication capabilities. For purposes of illustration, the user device 1502a and 1502b are user devices of a recruitment system of entities such as offices, educational institutes, etc.

The network 1501 is, for example, the internet, an intranet, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the need matching system 200 is accessible to the satellite internet of users, for example, through a broad spectrum of technologies and devices such as cellular phones, tablet computing devices, etc., with access to the internet.

As exemplarily illustrated in FIG. 15, the need matching system 200 comprises a non-transitory computer readable storage medium, for example, a memory unit 1506 for storing programs and data, and at least one processor 1503 communicatively coupled to the non-transitory computer readable storage medium. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the processor 1503. The non-transitory computer readable storage medium is configured to store computer program instructions defined by modules, for example, 1507, 201, 202, 203, 207, 210, 212, 221, 226, 228, 231 etc., of the need matching system 200. The modules 1507, 201, 202, 203, 207, 210, 212, 221, 226, 228, and 231 are installed and stored in the memory unit 1506 of the need matching system 200. The memory unit 1506 is used for storing program instructions, applications, and data. The memory unit 1506 is, for example, a random access memory (RAM) or another type of dynamic storage device that stores information and instructions for execution by the processor 1503. The memory unit 1506 also stores temporary variables and other intermediate information used during execution of the instructions by the processor 1503. The need matching system 200 further comprises a read only memory (ROM) or another type of static storage device that stores static information and instructions for the processor 1503.

The processor 1503 is configured to execute the computer program instructions defined by the modules, for example, 1507, 201, 202, 203, 207, 210, 212, 221, 226, 228, 231 etc., of the need matching system 200. The processor 1503 refers to any of one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 1503 is implemented as a processor set comprising, for example, a programmed microprocessor and a math or graphics co-processor. The processor 1503 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines)(IBM® processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The need matching system 200 disclosed herein is not limited to employing a processor 1503. In an embodiment, the need matching system 200 employs a controller or a microcontroller.

As exemplarily illustrated in FIG. 15, the need matching system 200 further comprises a data bus 1508, a network interface 1509, an input/output (I/O) controller 1510, input devices 1511, a fixed media drive 1512 such as a hard drive, a removable media drive 1513 for receiving removable media, output devices 1514, etc. The data bus 1508 permits communications between the modules, for example, 1507, 201, 202, 203, 207, 210, 212, 221, 226, 228, 231 etc., of the need matching system 200. The network interface 1509 enables connection of the need matching system 200 to the network 1501. In an embodiment, the network interface 1509 is provided as an interface card also referred to as a line card. The network interface 1509 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on a transmission control protocol (TCP)/internet protocol (IP), interfaces based on wireless communications technology such as satellite technology, radio frequency (RF) technology, near field communication, etc. The I/O controller 1510 controls input actions and output actions performed by the need matching system 200.

The display screen 1504, via the graphical user interface (GUI) 1504a, displays item attributes and the need attributes. The display screen 1504 is, for example, a video display, a liquid crystal display, a plasma display, an organic light emitting diode (OLED) based display, etc. The need matching system 200 provides the GUI 1504a on the display screen 1504. The GUI 1504a is, for example, an online web interface, a web based downloadable application interface, a mobile based downloadable application interface, etc. The display screen 1504 displays the GUI 1504a. The input devices 1511 are used for inputting data into the need matching system 200. The input devices 1511 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc. The output devices 1514 output the results of operations performed by the need matching system 200.

The modules of the need matching system 200 comprise a receiving module 1507, a merging module 201, a matching module 202, and a score generation module 203 stored in the memory unit 1506 of the need matching system 200. The receiving module 1507 receives a first attribute list comprising the item attributes in the item profiles and a second attribute list comprising the need attributes required for a need from a attribute list database 224. The merging module 201 performs merging actions on the item attributes in the first attribute list and returns a list of unique merged attributes present. The merging module 201 further combines multiple occurrences of the item attributes in the list of attributes present into one entry per item attribute in the list of unique merged attributes present with a combined amount present measure, that is, the merged amount measure, and a combined credibility measure, that is, the merged credibility measure. The merging module 201 further comprises a combining module 207 to combine multiple occurrences of the item attributes in the first attribute list, that is, the list of attributes present into a single merged attribute, that is, a unique item attribute with a corresponding merged amount measure and a corresponding merged credibility measure. The combining module 207 further configured to assemble the single sub-list of attributes present comprising the item attributes with corresponding computed attribute values into a list. The combining module 207 further comprises a compute attribute values module 210 and a attribute combiner 212. The compute attribute values module 210 computes attribute values, that is, a weighted attribute amount measure and a weighted credibility measure for each item attribute in the N sub-lists of attributes present. The compute attribute values module 210 further configured to return an item attribute in the sub-list of attributes present with the computed values of the weighted amount present measure and the weighted credibility measure. The attribute combiner 212 returns a single merged or combined attribute, that is, a unique item attribute on combining the enhanced attributes present tuples, that is, the tuples with the item attributes and corresponding weighted attribute amount measures and corresponding weighted credibility measures. The merging module 201 merges multiple reports or occurrences of an item attribute, wherein the reports are of mixed credibility measures.

The matching module 202 matches the list of unique merged attributes present and the second attribute list and returns a list of matched attribute entries. The matching module 202 further comprises an attribute entry matching module 221 and a create matched attribute module 226. The attribute entry matching module 221 receives the list of matched attribute entries and returning a list of matched attributes. The attribute entry matching module 221 is further configured to examine whether the list of unique merged attributes present contains the attributes needed, that is, the need attribute and passes the unique item attribute that is the same as the need attribute_present to the create matched attribute module 226.

The create matched attribute module 226 accepts the attribute_present and the need attribute and for creating a matched attribute tuple comprising a need attribute amount measure, an importance measure, and a requirement measure of the need attribute and a merged attribute amount measure and a merged credibility measure of the attribute_present. The score generation module 203 generates a need match score with the list of matched attributes and returns a single numerical match score. The score generation module 203 comprises a need match score generation module 228 and a final match score generation module 231. The need match score generation module 228 generates a scored matched attribute based on each matched attribute, additional values of a delta and a match score by determining the deviation in the merged attribute amount measure and the need attribute amount measure. The final match score generation module 231 calculates a single numerical match score by determining the degree of match between the need attributes and the item attributes. The need matching system 200 further comprise an operational system 1505 of a plurality of entities. The operational system 1505 of the need matching system 200 estimates the credibility of the item attribute amount measure corresponding to the item attributes and assigns the credibility measure based on the estimated credibility to the item attribute amount measure.

The need matching system 200 stores the item attributes in the item profiles and the need attributes required for a need in an attribute list database 224 of the need matching system 200. The attribute list database 224 of the need matching system 200 can be any storage area or medium that can be used for storing data and files. In an embodiment, the need matching system 200 stores the received information in external databases, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In another embodiment, the attribute list database 224 can be a location on a file system. In another embodiment, the attribute list database 224 can be remotely accessed by the need matching system 200 via the network 1301. In another embodiment, the attribute list database 224 is configured as a cloud based database implemented in a cloud computing environment, where computing resources are delivered as a service over the network 1501.

Computer applications and programs are used for operating the modules of the need matching system 200. The programs are loaded onto the fixed media drive 1512 and into the memory unit 1506 of the need matching system 200 via the removable media drive 1513. In an embodiment, the computer applications and programs are loaded directly on the need matching system 200 via the network 1501. The processor 1503 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., etc. The need matching system 200 employs the operating system for performing multiple tasks. The operating system is responsible for management and coordination of activities and sharing of resources of the need matching system 200. The operating system further manages security of the need matching system 200, peripheral devices connected to the need matching system 200, and network connections. The operating system employed on the need matching system 200 recognizes, for example, inputs provided by a user of the need matching system 200 using one of the input devices 1511, the output devices 1514, files, and directories stored locally on the fixed media drive 1512. The operating system on the need matching system 200 executes different programs using the processor 1503. The processor 1503 and the operating system together define a computer platform for which application programs in high level programming languages are written.

The processor 1503 of the need matching system 200 retrieves instructions defined by the receiving module 1507, the merging module 201, the matching module 202, the score generation module 203, the combining module 207, the compute attribute values module 210, the attribute combiner 212, the attribute entry matching module 221, the create matched attribute module 226, the need match score generation module 228, and the final match score generation module 231 for performing respective functions disclosed above. The processor 1503 retrieves instructions for executing the modules, for example, 1507, 201, 202, 203, 207, 210, 212, 221, 226, 228, 231, etc., of the need matching system 200 from the memory unit 1506. A program counter determines the location of the instructions in the memory unit 1506. The program counter stores a number that identifies the current position in the program of each of the modules, for example, 1507, 201, 202, 203, 207, 210, 212, 221, 226, 228, 231 etc., of the need matching system 200. The instructions fetched by the processor 1503 from the memory unit 1506 after being processed are decoded. The instructions are stored in an instruction register in the processor 1503. After processing and decoding, the processor 1503 executes the instructions, thereby performing one or more processes defined by those instructions.

At the time of execution, the instructions stored in the instruction register are examined to determine the operations to be performed. The processor 1503 then performs the specified operations. The operations comprise arithmetic operations and logic operations. The operating system performs multiple routines for performing a number of tasks required to assign the input devices 1511, the output devices 1514, and the memory unit 1506 for execution of the modules, for example, 1507, 201, 202, 203, 207, 210, 212, 221, 226, 228, 231, etc., of the need matching system 200. The tasks performed by the operating system comprise, for example, assigning memory to the modules, for example, 1507, 201, 202, 203, 207, 210, 212, 221, 226, 228, 231, etc., of the need matching system 200 and to data used by the need matching system 200, moving data between the memory unit 1506 and disk units, and handling input/output operations. The operating system performs the tasks on request by the operations and after performing the tasks, the operating system transfers the execution control back to the processor 1503. The processor 1503 continues the execution to obtain one or more outputs. The outputs of the execution of the modules, for example, 1507, 201, 202, 203, 207, 210, 212, 221, 226, 228, 231, etc., of the need matching system 200 are displayed to a user of the need matching system 200 on the output device 1514. In an embodiment, one or more portions of the need matching system 200 are distributed across one or more computer systems (not shown) coupled to the network 1501.

The non-transitory computer readable storage medium having embodied thereon, computer program codes comprising instructions executable by at least one processor 1503 for determining a degree of match between item profiles with item attributes of varying credibility and needs with need attributes of varying importance. The computer program codes comprise a first computer program code for receiving a first attribute list comprising the item attributes in the item profiles and a second attribute list comprising the need attributes required for a need from a attribute list database 224 by the need matching system 200, wherein the first attribute list comprises first tuples, each of the first tuples comprising one of the item attributes, an item attribute amount measure corresponding to the one of the item attributes, and a credibility measure indicating credibility of the item attribute amount measure, and wherein the second attribute list comprises second tuples, each of the second tuples comprising one of the need attributes, a requirement measure, an importance measure, and an need attribute amount measure associated with the one of the need attributes; a second program code for creating a unique attribute list comprising unique item attributes from the first attribute list, a merged attribute amount measure corresponding to each of the unique item attributes, and a merged credibility measure indicating credibility of the merged attribute amount measure by the need matching system 200 by performing merging actions on the first tuples in the first attribute list, wherein the merging actions comprise computing the merged attribute amount measure and the merged credibility measure corresponding to the each of the unique item attributes using the item attribute amount measure and the credibility measure of each of the item attributes of the first attribute list; a third computer program code for creating a matched attribute list by matching the unique item attributes of the created unique attribute list with the need attributes of the second attribute list by the need matching system 200 on combining the created unique attribute list with the second attribute list; a fourth computer program code for generating a attribute match score for each of the need attributes in the created matched attribute list on matching the unique item attributes with the need attributes by the need matching system 200 using the requirement measure, the importance measure, the need attribute amount measure, the merged attribute amount measure, and the merged credibility measure; and a fifth computer program code for generating a need match score defining the degree of match between the item profiles and the needs by the need matching system 200 by processing the generated attribute match score for the each of the need attributes with the importance measure of the each of the need attributes in the second attribute list.

The non-transitory computer readable storage medium further comprise a sixth computer program code for determining whether a need attribute is absent in the created unique attribute list and assigning default values to the merged attribute amount measure and the merged credibility measure corresponding to the need attribute in the matched attribute list by the need matching system 200. The non-transitory computer readable storage medium, wherein fifth computer program code further comprise a seventh computer program code for determining deviations in the merged attribute amount measure and the need attribute amount measure by the need matching system 200 using an amount measure deviation lookup table.

It will be readily apparent in different embodiments that the various methods, algorithms, and computer programs disclosed herein are implemented on non-transitory computer readable storage media appropriately programmed for computing devices. The non-transitory computer readable storage media participates in providing data, for example, instructions that are read by a computer, a processor or a similar device. In different embodiments, the “non-transitory computer readable storage media” further refers to a single medium or multiple media, for example, a centralized database, a distributed database, and/or associated caches and servers that store one or more sets of instructions that are read by a computer, a processor or a similar device. The “non-transitory computer readable storage media” further refers to any medium capable of storing or encoding a set of instructions for execution by a computer, a processor or a similar device and that causes a computer, a processor or a similar device to perform any one or more of the methods disclosed herein. Common forms of non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft®.NET, Objective-C®, etc. Other object-oriented, functional, scripting, and/or logical programming languages can also be used. In an embodiment, the computer program codes or software programs are stored on or in one or more mediums as object code. In another embodiment, various aspects of the computer implemented method and the need matching system 200 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the computer implemented method and the need matching system 200 disclosed herein are implemented as programmed elements, or non-programmed elements, or any suitable combination thereof.

Where databases are described such as the attribute list database 224, it will be understood by one of ordinary attribute in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary attribute in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the need matching system 200, the databases are integrated to communicate with each other for enabling simultaneous updates of data linked across the databases, when there are any updates to the data in one of the databases.

The computer implemented method and the need matching system 200 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The computer implemented method and the need matching system 200 disclosed herein are not limited to a particular computer system platform, processor, operating system, or network. In an embodiment, one or more aspects of the computer implemented method and the need matching system 200 disclosed herein are distributed among one or more computer systems, for example, servers configured to provide one or more services to one or more client computers, or to perform a complete task in a distributed system. For example, one or more aspects of the computer implemented method and the need matching system 200 disclosed herein are performed on a client-server system that comprises components distributed among one or more server systems that perform multiple functions according to various embodiments. These components comprise, for example, executable, intermediate, or interpreted code, which communicate over a network using a communication protocol. The computer implemented method and the need matching system 200 disclosed herein are not limited to be executable on any particular system or group of systems, and are not limited to any particular distributed architecture, network, or communication protocol.

The foregoing examples have been provided merely for explanation and are in no way to be construed as limiting of the method and the need matching system 200 disclosed herein. While the method and the need matching system 200 have been described with reference to various embodiments, it is understood that the words, which have been used herein, are words of description and illustration, rather than words of limitation. Furthermore, although the method and the need matching system 200 have been described herein with reference to particular means, materials, and embodiments, the method and the need matching system 200 are not intended to be limited to the particulars disclosed herein; rather, the method and the need matching system 200 extend to all functionally equivalent structures, methods and uses, such as are within the scope of the appended claims. While multiple embodiments are disclosed, it will be understood by those attributeed in the art, having the benefit of the teachings of this specification, that the method and the need matching system 200 disclosed herein are capable of modifications and other embodiments may be effected and changes may be made thereto, without departing from the scope and spirit of the method and the need matching system 200 disclosed herein.

We claim:

1. A method for determining a degree of match between a plurality of item profiles with a plurality of item attributes with a plurality of varying ratings of varying credibility and a plurality of need profiles with a plurality of need attributes of varying importance, the method employing a need matching system comprising at least one processor configured to execute computer program instructions for performing the method comprising:
receiving a first attribute list comprising the item attributes in the item profiles and a second attribute list comprising the need attributes required for a need from an attribute list database by the need matching system, wherein the first attribute list comprises a plurality of first tuples, each of the first tuples comprising one of the item attributes, an item attribute amount measure corresponding to the one of the item attributes, and a credibility measure indicating credibility of the item attribute amount measure, and wherein the second attribute list comprises a plurality of second tuples, each of the second tuples comprising one of the need attributes, a requirement measure, an importance measure, and a need attribute amount measure associated with one of the need attributes;
creating a unique attribute list comprising unique item attributes from the first attribute list, a merged attribute amount measure corresponding to each of the unique item attributes, and a merged credibility measure indicating credibility of the merged attribute amount measure by the need matching system by performing merging actions on the first tuples in the first attribute list, wherein the merging actions comprise computing the merged attribute amount measure and the merged credibility measure corresponding to the each of the unique item attributes using the item attribute amount measure and the credibility measure of each of the item attributes of the first attribute list;
creating a matched attribute list by matching the unique item attributes of the created unique attribute list with the need attributes of the second attribute list by the need matching system on combining the created unique attribute list with the second attribute list;
generating an attribute match score for each of the need attributes in the created matched attribute list on matching the unique item attributes with the need attributes by the need matching system using the requirement measure, the importance measure, the need attribute amount measure, the merged attribute amount measure, and the merged credibility measure; and
generating a need match score defining the degree of match between the item profiles and the need profiles by the need matching system by processing the generated attribute match score for the each of the need attributes with the importance measure of the each of the need attributes in the second attribute list.

2. The method of claim 1, further comprising determining whether a need attribute is absent in the created unique attribute list and assigning default values to the merged attribute amount measure and the merged credibility measure corresponding to the need attribute in the matched attribute list by the need matching system.

3. The method of claim 1, wherein the item attribute is one of a core trait and a domain of expertise of an item extracted from the item profiles.

4. The method of claim 1, wherein the generation of the attribute match score for each of the need attributes in the created matched attribute list comprises determining one or more deviations in the merged attribute amount measure and the need attribute amount measure by the need matching system using an amount measure deviation lookup table.

5. The method of claim 1, wherein the item attribute amount measure is a fraction of a total attribute amount measure of the item attributes possessed by items associated with the item profiles, and wherein the need attribute amount measure is a quantized value of the proficiency of one or more of the items required for the need.

6. The method of claim 1, comprises:
estimating the credibility of the item attribute amount measure corresponding to the item attributes; and
assigning the credibility measure based on the estimated credibility to the item attribute amount measure.

7. The method of claim 1, wherein the requirement measure is a Boolean value associated with a need attribute representing that the item attribute amount measure of the item attribute is required to be equal to the need attribute amount measure of the need attribute, wherein the need attribute is same as the item attribute, and wherein the importance measure is a quantized value representing a degree to which presence of the need attribute in the first attribute list is required for a need.

8. The method of claim 1, wherein the unique item attributes is a list of item attributes with multiple occurrences in the first attribute list that are merged to a single occurrence.

9. The method of claim 1, wherein the merged attribute amount measure is a combined value of the item attribute amount measures corresponding to the multiple occurrences of the item attributes in the first attribute list, and wherein the merged credibility measure is a combined value of the credibility measures corresponding to the multiple occurrences of the item attributes in the first attribute list.

10. The method of claim 9, wherein a credibility bump is added to an unadjusted credibility measure to generate a merged credibility measure of the item attribute based on the number of reports and credibility of the reports.

11. The method of claim 1 further comprises merging multiple reports or occurrences of an item attribute, wherein the reports are of mixed credibility measures.

12. A method for generating an an attribute match score implemented by a need matching system on comparison of a plurality of item attributes of varying credibility with a plurality of need attributes of varying importance, the method comprising:
performing merging actions on a plurality of first tuples in a first attribute list and returning a list comprising a plurality of unique merged attributes present by a merging module of the need matching system;
matching the list of unique merged attributes present and a second attribute list and returning a list of matched attribute entries by a matching module of the need matching system; and
generating a need match score with the list of matched attributes and returning a single numerical match score by a score generation module of the need matching system.

13. The method of claim 12, further comprising receiving the list of matched attribute entries by an attribute entry matching module of the matching module and returning a list of matched attributes by the attribute entry matching module.

14. A need matching system for determining a degree of match between a plurality of item profiles with a plurality of item attributes with a plurality of varying ratings of varying credibility and a plurality of need profiles with a plurality of need attributes of varying importance, the need matching system comprising:
a non-transitory computer readable storage medium configured to store computer program instructions defined by modules of the need matching system; and
at least one processor communicatively coupled to the non-transitory computer readable storage media, the at least one processor configured to execute computer program instructions defined by modules of the need matching system, the modules comprising:
a receiving module for receiving a first attribute list comprising the item attributes in the item profiles and a second attribute list comprising the need attributes required for a need from an attribute list database, wherein the first attribute list comprises a plurality of first tuples, each of the first tuples comprising one of the item attributes, an item attribute amount measure corresponding to the one of the item attributes, and a credibility measure indicating credibility of the item attribute amount measure, and wherein the second attribute list comprises a plurality of second tuples, each of the second tuples comprising one of the need attributes, a requirement measure, an importance measure, and a need attribute amount measure associated with the one of the need attributes;
a merging module for creating a unique attribute list comprising unique item attributes from the first attribute list, a merged attribute amount measure corresponding to each of the unique item attributes, and a merged credibility measure indicating credibility of the merged attribute amount measure by performing merging actions on the first tuples in the first attribute list, wherein the merging actions comprise computing the merged attribute amount measure and the merged credibility measure corresponding to the each of the unique item attributes using the item attribute amount measure and the credibility measure of each of the item attributes of the first attribute list;
a matching module for creating a matched attribute list by matching the unique item attributes of the created unique attribute list with the need attributes of the second attribute list on combining the created unique attribute list with the second attribute list;
a score generation module for generating an attribute match score for each of the need attributes in the created matched attribute list on matching the unique item attributes with the need attributes using the requirement measure, the importance measure, the need attribute amount measure, the merged attribute amount measure, and the merged credibility measure; and
a final match score generation module for generating a need match score defining the degree of match between the item profiles and the need profiles by processing the generated attribute match score for the each of the need attributes with the importance measure of the each of the need attributes in the second attribute list.

15. The need matching system of claim 14 further comprising an attribute entry match module for fetching a need attribute from the attribute list database and pass the fetched need attribute, if the need attribute is absent in the unique attribute list, wherein the need matching syetm assigns default values to the merged attribute amount measure and the merged credibility measure corresponding to the need attribute in the matched attribute list by the need matching system.

16. The need matching system of claim 14 further comprising a need match score generation module for generating a scored matched attribute based on each matched attribute, additional values of a delta and a match score by determining deviation in the merged attribute amount measure and the need attribute amount measure using an amount measure deviation lookup table in the attribute list database.

17. The need matching system of claim 14 further comprising an operational system configured to:
estimate the credibility of the item attribute amount measure corresponding to the item attributes; and
assign the credibility measure based on the estimated credibility to the item attribute amount measure.

18. The need matching system of claim 14, wherein the merging module further comprises a combining module for combining multiple occurrences of the item attributes in the first attribute list into a unique item attribute with a corresponding merged amount measure and a corresponding merged credibility measure, wherein the combining module further comprises:
a compute attribute values module for computing a weighted attribute amount measure and a weighted credibility measure for each item attribute in N sub-lists of the attributes present, wherein the merging module sorts the list of attributes present by the item attributes and splits the list of attributes present into the N sub-lists of the attributes present, where each sub-list of attributes present contains entries for a common attribute; and
a skill combiner for returning a single merged or combined skill, that is, a unique opportunity seeker skill on combining the enhanced skills present tuples, that is, the tuples with the opportunity seeker skills and corresponding weighted skill amount measures and corresponding weighted credibility measures.

19. The need matching system of claim 14, wherein the merging module merges multiple reports of an item attribute, wherein the reports are of mixed credibility measures.

20. The need matching system of claim 14, wherein the matching module further comprises:
an attribute entry matching module for receiving the list of matched attribute entries and returning a list of matched attributes; and
a create matched attribute module for accepting attribute_present and the need attribute and for creating a matched attribute tuple comprising a need attribute amount measure, need attribute and a merged attribute amount measure and a merged credibility measure of the attribute _present.

21. The need matching system of claim 14, wherein the scoring module further comprises:
a need match score generation module for generating a scored matched attribute based on each matched attribute, plurality of additional values of a delta and a match score by determining the deviation in the merged attribute amount measure and the need attribute amount measure; and
a final match score generation module for calculating a single numerical match score by determining the degree of match between the need attributes and the item attributes.

22. The need matching system of claim 14, wherein the combining module is further configured for assembling the single sub-list of attributes present comprising the item attributes with corresponding computed attribute values into a list.

23. The need matching system of claim 14, wherein the compute attribute values module is further configured for returning an item attribute in the sub-list of attributes present with the computed values of the weighted amount present measure and the weighted credibility measure.

24. The need matching system of claim 14, wherein the attribute entry matching module is further configured for examining whether the list of unique merged attributes present contains the attributes needed and pass the unique item attribute that is the same as the need attribute_present to the create matched attribute module.

25. A non-transitory computer readable storage medium having embodied thereon, computer program codes comprising instructions executable by at least one processor for determining a degree of match between a plurality of item profiles with a plurality of item attributes with a plurality of varying ratings of varying credibility and a plurality of need profiles with a plurality of need attributes of varying importance, the computer program codes comprising:
a first computer program code for receiving a first attribute list comprising the item attributes in the item profiles and a second attribute list comprising the need attributes required for a need from an attribute list database by the need matching system, wherein the first attribute list comprises a plurality of first tuples, each of the first tuples comprising one of the item attributes, an item attribute amount measure corresponding to the one of the item attributes, and a credibility measure indicating credibility of the item attribute amount measure, and wherein the second attribute list comprises a plurality of second tuples, each of the second tuples comprising one of the need attributes, a requirement measure, an importance measure, and a need attribute amount measure associated with the one of the need attributes;
a second computer program code for creating a unique attribute list comprising unique item attributes from the first attribute list, a merged attribute amount measure corresponding to each of the unique item attributes, and a merged credibility measure indicating credibility of the merged attribute amount measure by the need matching system by performing merging actions on the first tuples in the first attribute list, wherein the merging actions comprise computing the merged attribute amount measure and the merged credibility measure corresponding to the each of the unique item attributes using the item attribute amount measure and the credibility measure of each of the item attributes of the first attribute list;
a third computer program code for creating a matched attribute list by matching the unique item attributes of the created unique attribute list with the need attributes of the second attribute list by the need matching system on combining the created unique attribute list with the second attribute list;
a fourth computer program code for generating an attribute match score for each of the need attributes in the created matched attribute list on matching the unique item attributes with the need attributes by the need matching system using the requirement measure, the importance measure, the need attribute amount measure, the merged attribute amount measure, and the merged credibility measure; and
a fifth computer program code for generating a need match score defining the degree of match between the item profiles and the need profiles by the need matching system by processing the generated attribute match score for the each of the need attributes with the importance measure of the each of the need attributes in the second attribute list.

26. The non-transitory computer readable storage medium of claim 25 further comprise a sixth computer program code for determining whether a need attribute is absent in the created unique attribute list and assigning default values to the merged attribute amount measure and the merged credibility measure corresponding to the need attribute in the matched attribute list by the need matching system.

27. The non-transitory computer readable storage medium of claim 25, wherein fifth computer program code further comprise a seventh computer program code for determining one or more deviations in the merged attribute amount measure and the need attribute amount measure by the need matching system using an amount measure deviation lookup table.
